(19) United States
(12) Patent Application Publication
(10) Pub. No.: US 2015/0039657 A1
(43) Pub. Date: Feb. 5, 2015

(54) Apparatus, Method, and System for Developing Procedures, Assessing Risk, and Generating Automated Flowcharts

(71) Applicant: Operational Risk Management, LLC, Monterery, CA (US)

(72) Inventors: Jeffrey J. Roth, Monterery, CA (US); Ram Vanga, Alpharetta, GA (US)

(21) Appl. No.: 14/330,293

(22) Filed: Jul. 14, 2014

Related U.S. Application Data
(60) Provisional application No. 61/859,933, filed on Jul. 30, 2013.
(60) Provisional application No. 61/860,743, filed on Jul. 31, 2013.

(51) Int. Cl. G06F 17/30; G06F 3/0484

(52) U.S. Cl. CPC G06F 17/30289; G06F 3/0484
USPC 707/805

(57) ABSTRACT

A system that automatically creates and diagrams a process flowchart based upon a dataset created from a set of tables from a database by a user. The method of documentation enables users to automate the preparation and maintenance of process flowcharts. A system that performs and documents business process analysis with integrated automated process flowcharts. The method of documentation enables users to automate the documentation and flowcharts of ownership, risk scenarios, risk consequences, control mechanisms, and risk assessments vulnerabilities at a process step level. A system that automatically creates written operating procedures for a business process based on a dataset created from a set of tables from a database by a user. The method of documentation enables users to automate the preparation and maintenance of operating procedures.

### RELATED APPLICATIONS

This application claims priority to U.S. Provisional Application Ser. No. 61/859,933, filed Jul. 30, 2013, entitled “Apparatus, Method, and System for Developing Procedures, Assessing Risk, and Generating Automated Flowcharts,” by Roth et al., the entire contents of which application is incorporated by reference as if fully set forth herein.

This application also claims priority to U.S. Provisional Application Ser. No. 61/860,743, filed Jul. 31, 2013, entitled “Apparatus, Method, and System for Developing Procedures, Assessing Risk, and Generating Automated Flowcharts,” by Roth et al., the entire contents of which application is incorporated by reference as if fully set forth herein.

### FIELD OF THE TECHNOLOGY

At least some embodiments disclosed herein relate to developing procedures, assessing risk, and generating automated flowcharts in general.

### BRIEF DESCRIPTION OF THE DRAWINGS

Various embodiments are illustrated by way of example and not limitation in the figures of the accompanying drawings in which like references indicate similar elements.

FIGS. 1-55 illustrate various features of systems for developing procedures, assessing risk, and generating automated flowcharts according to various embodiments, as described in more detail below.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Systems and methods to develop procedures, assess risk, and generate automated flowcharts are described herein. Various embodiments are described below. The disclosure includes methods and apparatuses which perform these methods, including data processing systems which perform these methods, and computer readable media containing instructions which when executed on data processing systems cause the systems to perform these methods.

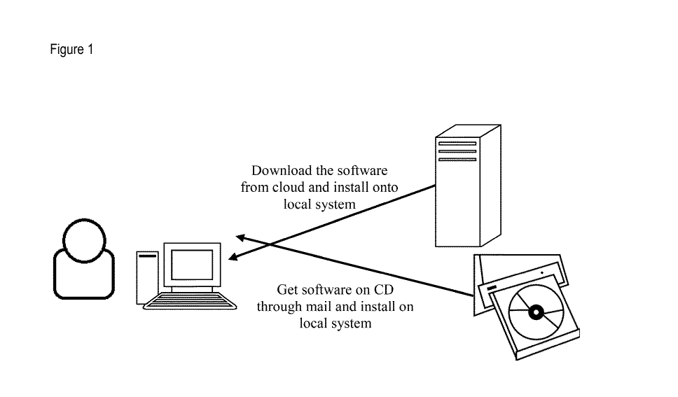

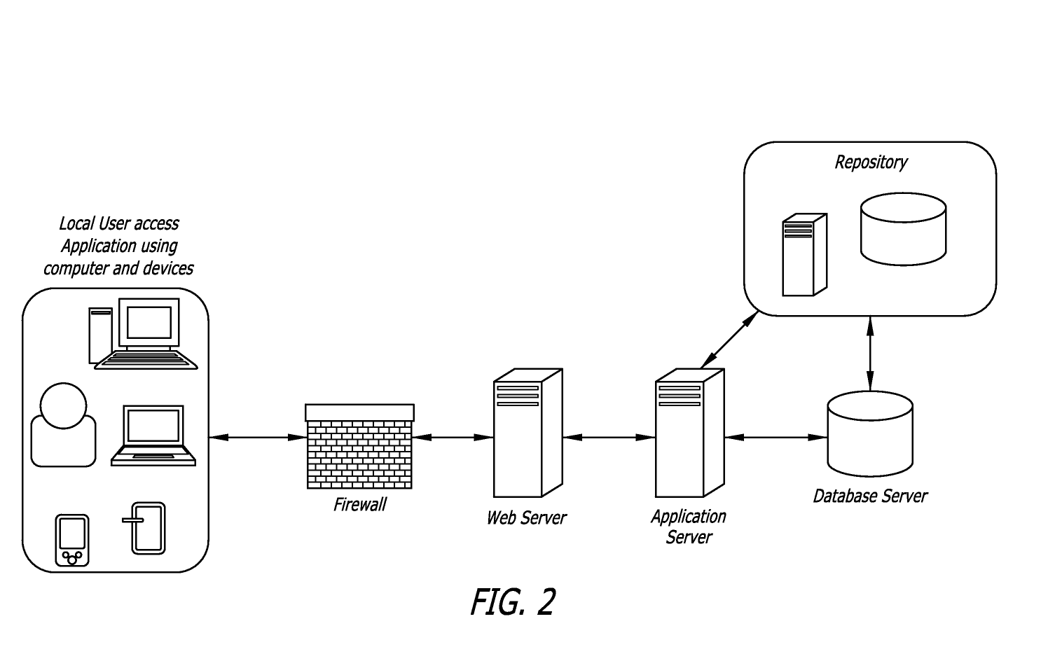

A process flowchart is a graphical representation of a process using annotated figures connected by flow lines for the purpose of designing or documenting a process. The approach described herein automatically generates all elements of a flowchart diagram based upon a dataset created from tables containing process step data input by a user. This includes all flow lines, arrows, shapes and text for the diagram. The flowchart diagram is then output and displayed for review and printing. The flowchart software is either loaded onto the user's computer or device, or accessible through the internet in a cloud environment. Refer to FIGS. 1 and 2.

The current state of flowchart technology has the same basic elements: users create flowcharts by selecting symbols from a gallery, inserting and moving symbols on a drawing canvas, connecting symbols with a drop-down of flow line choices, inserting text within symbols, and adding headings and other text to the canvas. Then, the individual pages of the drawing canvas are saved in a file.

Despite the existing technology, the concept of how to construct a graphical representation of a process is not necessarily intuitive to most people. Many people can sit down with a pen and paper, and describe a process. However, depicting that process in a flowchart is completely foreign to them. In addition, existing flowchart technology is time-consuming and cumbersome to use as described later. The approach in the disclosure herein overcomes these concerns as it is far quicker and easier to build and maintain a flowchart using a user interface than a canvas.

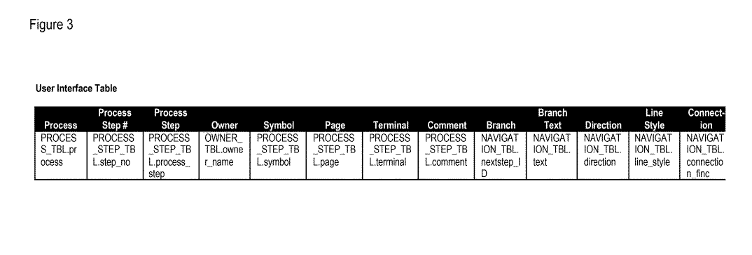

A process flowchart consists of a series of process steps connected by flow lines. The process step is the activity (e.g., task, function or decision) being performed at a particular stage in the process life cycle. Using current flowchart technology, the user documents the process steps on a canvas. With the disclosed approach, the user documents the process steps by completing fields in a user interface that are mapped to table elements within database tables. Refer to FIG. 3.

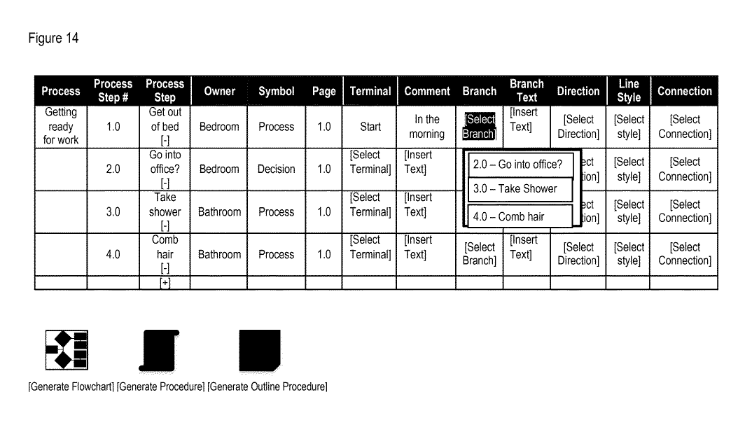

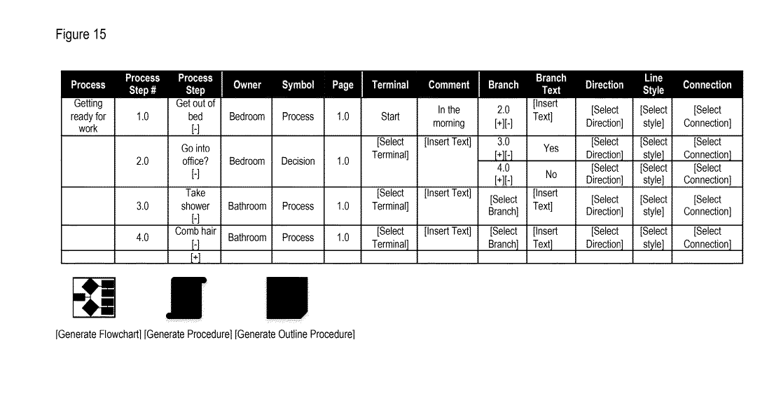

The user interface consists of rows comprising the individual process steps. For example, the first process step in the process, “Getting ready for work”, may be “Getting out of bed” which is followed by the process step of deciding, “Am I going into the office?” because going to the office necessitates the process step, “Take a shower” whereas working from home does not, and then followed by the process step, “Brush teeth”. In this example, the user interface would consist of four rows with a column for the process step number (e.g., 1.0, 2.0, 3.0 and 4.0) and each process step (i.e., Getting out of bed). Refer to FIG. 14.

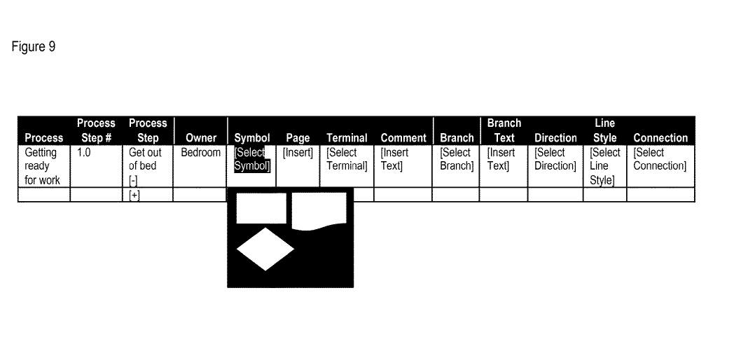

The user interface contains other fields wherein the user inputs information about the process step. One of the fields in the table is the user designation of the symbol that best represents the process step. In the example, the user designates the first process step with a process symbol, the second process step with a decision symbol, and the third and fourth process steps with process symbols. Refer to FIG. 9.

Another field contained in the user interface is the branch. The branch is the user designation of which process step immediately follows the process step. In some cases, a single process step may have multiple branches such as when the process step is a decision. In the example, the user designates in the first process step 1.0 that the process step 2.0 is a branch. In process step 2.0, the user designates that process step 3.0 is a branch on a ‘Yes’ response and process step 4.0 is a branch on a ‘No’ response. In process step 3.0, the user designates that 4.0 is a branch. Refer to FIG. 15.

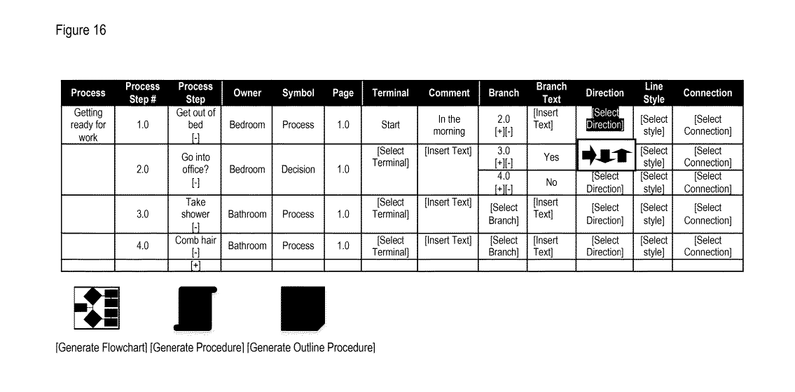

Referring to FIG. 16, the direction field of the user interface enables the user to designate whether the branch is located to the right, above or below of the process step. Additional fields in the user interface further enhance the flowchart and its flowcharting capabilities, which are described in detail in Section I below.

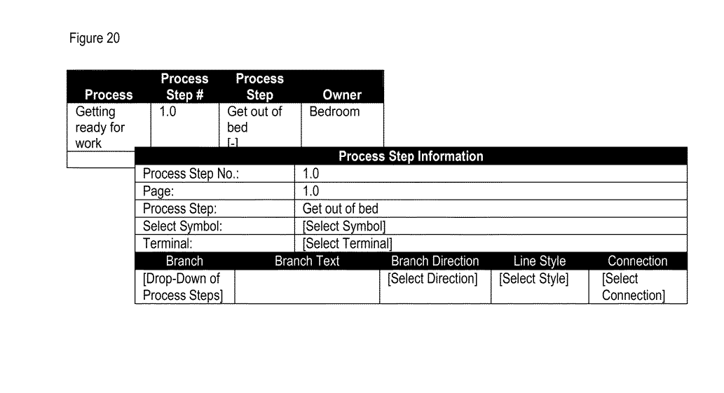

In an additional embodiment of the method, fields in the user interface may be displayed for input and edit by a user in a page format rather than a tabular format. Refer to FIG. 20.

Unlike current flowchart technology, the disclosed approach does not necessitate that the user save the completed flowchart as a user file. That's because a computer system (as used herein, a “computer system” generally refers to one or more processors, computing devices and/or other computing hardware that are used to perform a method/approach and/or implement a system described herein) automatically generates the flowchart whenever selected by a user. Since the system creates the flowchart diagram from database tables, any change in the tables automatically updates the flowchart diagram. In another embodiment of the method, the disclosed approach enables the user to manipulate the flowchart diagram generated by the computer system and save the changes.

The disclosed approach facilitates flowchart automation that would not be possible using current flowchart technology. For example, when inserting a new process step between two existing process steps using existing flowchart technology, a user must: (1) move the symbols to another area of the canvas, (2) select the symbol, (3) position the symbol on the page, (4) add the process step text, (5) move the symbols in (1) to follow the new process step, and (6) insert a flow line from the new symbol. If the new process step causes there to be too many symbols on the page, the user must then: (7) move all of the symbols on the following page to accommodate the symbols that had to be moved from the previous page, (8) cut and paste those symbols from the previous page, (9) move the symbols in (7) to follow the inserted symbols, (10) re-position the off-page connection symbols on both pages, and (11) modify the flow lines. Hopefully, the changes do not cause there to now be too many symbols on this page. If the process steps are numbered, the user must manually modify every step that follows the new step. A similar labor-intensive process is necessitated when removing or moving a process step using existing flowchart technology.

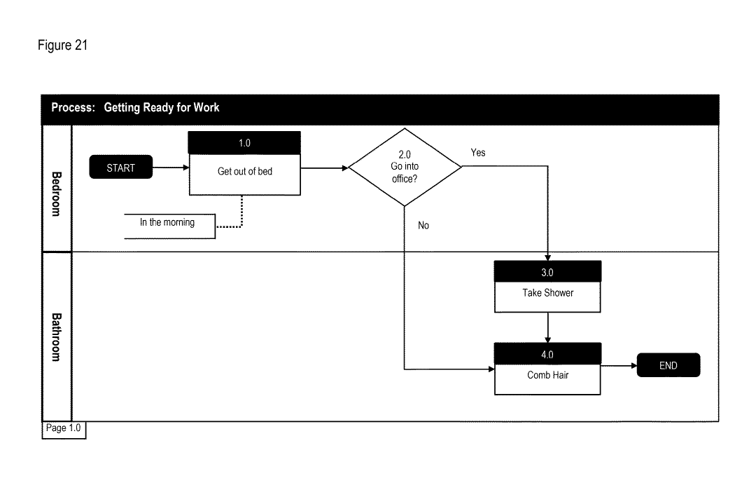

However, the user accomplishes the same flowchart output using the disclosed approach with simple edits of the user interface. For example, when inserting a new process step between two existing process steps using the disclosed approach, the user: (1) adds the new process step to the table, (2) selects the symbol, (3) selects the branch, and (4) selects the direction. Then, the user presses a “Generate Flowchart” button, as described in more detail below. If the new process step causes there to be too many symbols on the page, the user: (5) designates the page number that the process step should appear. The computer system automatically adds, moves, or removes symbols and text, modifies flow lines, adjusts page presentation and off-page connections, re-numbers process steps, and draws other diagram elements. Refer to FIG. 21, which illustrates a system-generated flowchart using the example described above.

In other embodiments of the method, the disclosed approach creates the entire flowchart with the user only having to input a minimal amount of information (e.g., process step, branch, and branch text) rather than manually selecting the process step symbol, line style, direction, and other characteristics about the process flow. Using pre-defined conditions, logic, and criteria established by the user and computer system, the computer system automatically determines which process step symbol, line style, direction, and other characteristics about the process flow to use. Then, the computer system determines the layout of the symbols on a page, distribution of symbols across multiple pages, and establishes both the on-page and off-page connections.

Using the disclosed approach, the database tables described above can contain any number of table elements that are mapped to the user interface wherein the user inputs information about the process step. In an additional embodiment of the method, the computer system includes additional database tables and table elements, mapped to the user interface, which integrate risk management data into the flowchart diagram and spreadsheet reports as described below.

In many industries, flowcharts are used to analyze and assess risks and controls within a business process. For example, the payment processing process consists of receiving a payment, crediting the customer's account, and posting the transaction to the general ledger. The process is exposed to financial reporting risk, operational risk, and compliance risk, amongst others. These risks are mitigated by such control activities as reconciliations and supervisory reviews of suspense accounts. As a risk analysis tool, the flowchart helps identify the process steps, the business unit that performs each step, the risks present within the process step, and the controls used to mitigate those risks. Because multiple business units may participate in a business process, the process steps are generally organized by business unit in a process flowchart.

To document the risks and controls that apply to a process step, practitioners cross-reference the process step number in the flowchart to a spreadsheet that details the process, process step number, process step, and business unit ownership, as well as risk scenarios, risk consequences, regulations, controls, control evaluations, action plans, and other risk management data (collectively referred to as “risk management data” and individually referred to as a “risk management data element”). As an alternative method, some practitioners notate the relevant risk ID and control ID numbers with the process step in the flowchart that is cross-referenced to a spreadsheet report that details the risk management data. Because the latter method incorporates the risk and control ID's in the flowchart, it is easier for a user to visualize disparities in process steps such as process steps impacted by multiple risks or those where controls are absent. Other than that additional benefit, both methods generally produce the same output.

The inability to integrate the flowchart with the spreadsheet report is another weakness of current flowchart technology. Consequently, changes in the flowchart necessitate manual changes in the spreadsheet report and extra effort to ensure both are in sync. Also, many practitioners format the document wherein the flowchart is at the top of the page while the spreadsheet information is at the bottom of the page. As a result, flowchart changes may also necessitate moving spreadsheet information from page to page.

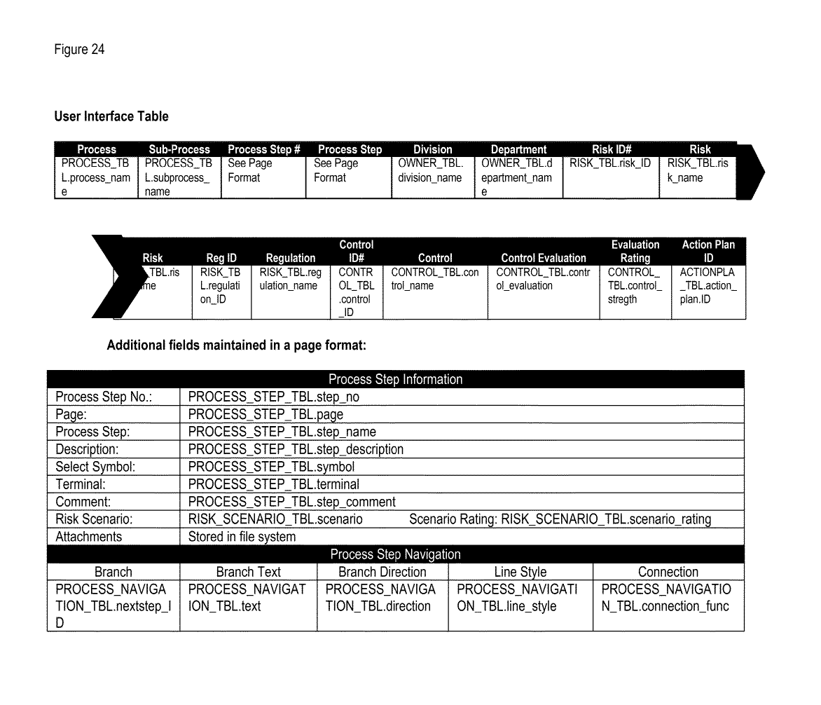

Referring to FIG. 24, database tables in the computer system include risk management data as table elements, which are mapped to the user interface. Using the user interface, the user inputs the risk management data as well as the business unit owner applicable to a process step. One or many risk scenarios, risks, regulations, controls and control evaluations may be associated with a single process step. Since the user is inputting the risk management data by process step, the risk management data is automatically correlated to the process step that it applies.

Many organizations maintain complex risk management systems. A risk management system consists of databases and relationships between tables comprising risk management data, business units, and business processes. However, risk management systems generally do not analyze and assess risk at a process step level. Furthermore, current flowchart technology is not integrated with a business' risk management system or other business management systems. Consequently, it is difficult to ensure the consistency and integrity of data maintained in the risk management system, process flowcharts and spreadsheet reports.

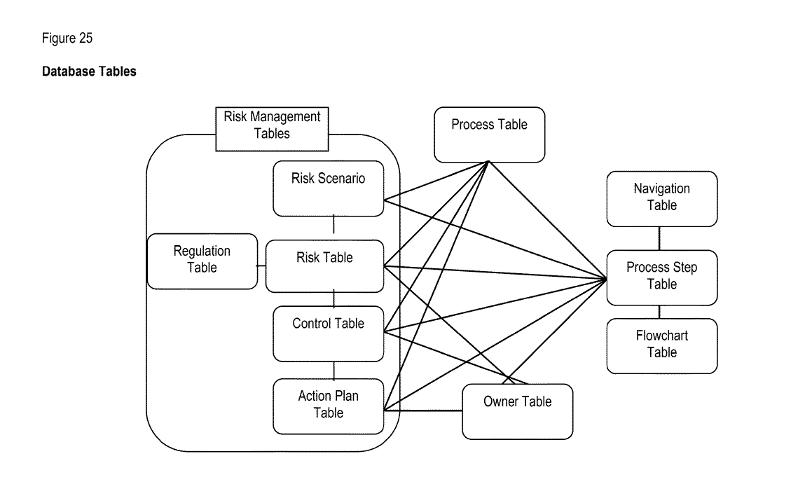

In another embodiment of the method, risk management data is retrieved from the organization's risk management systems rather than manually input by the user. Referring to FIG. 25, the computer system retrieves data from the risk management system either by: 1) accessing the data tables of the risk management system directly, or 2) accessing the risk management database table in the computer system that has been populated from data contained in the organization's risk management systems.

Since the data residing in the risk management system is not initially correlated to process steps, the user establishes the relationship between a process step and risk management data by selecting the applicable risk management data element from a list of data retrieved from the risk management system. For example, rather than manually inputting a risk, the user selects the specific risk that applies to the process step from a list of risks retrieved from the risk management system.

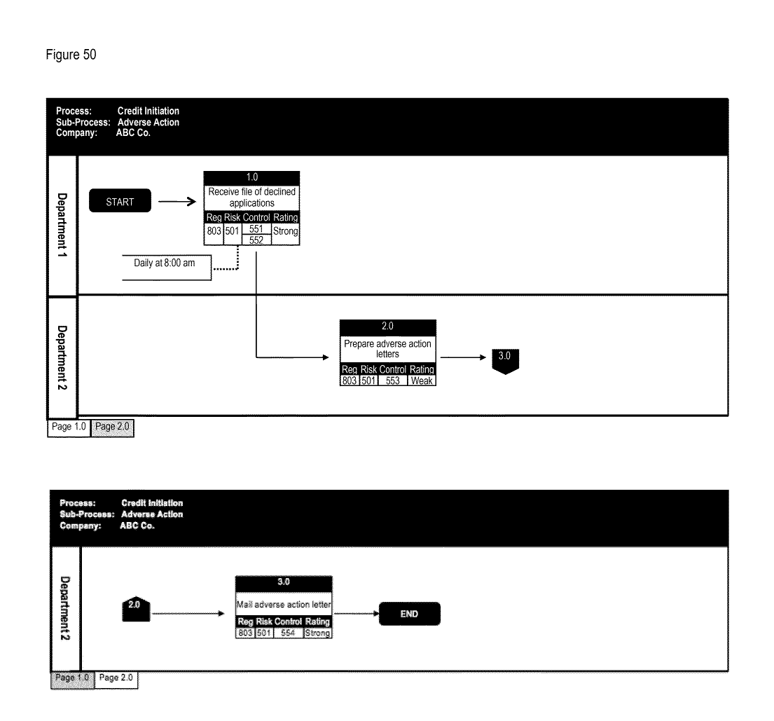

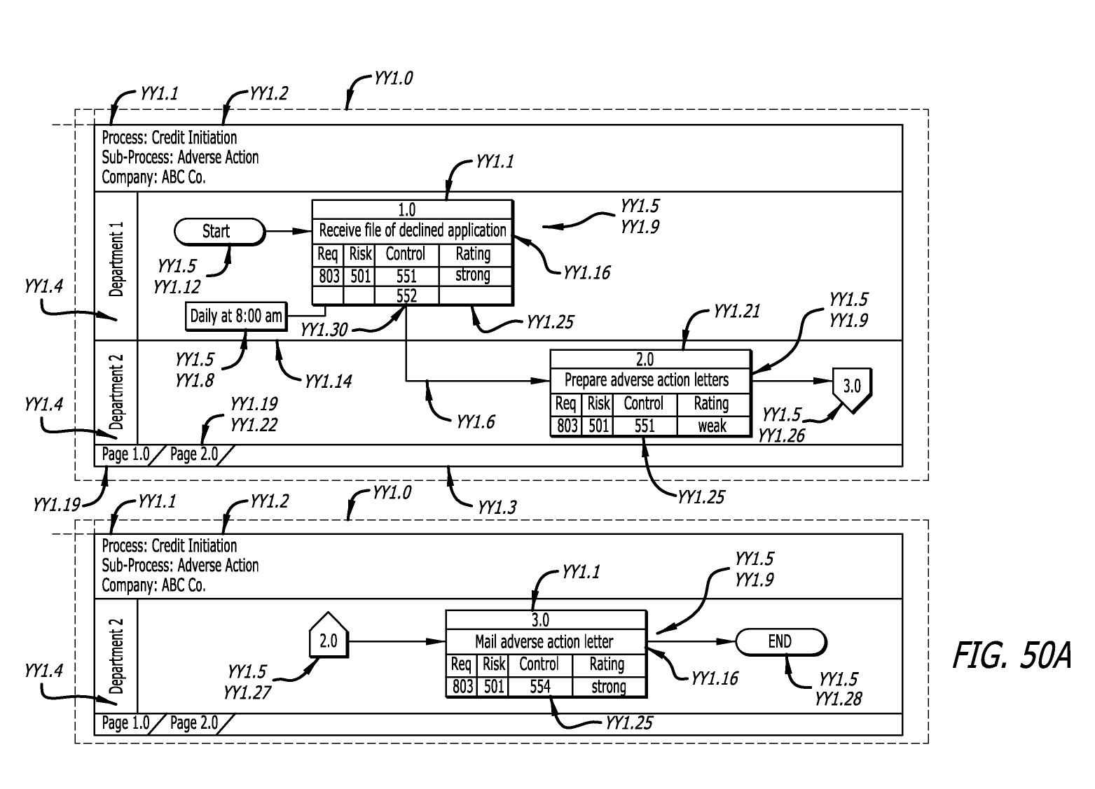

When a user either inputs or selects the information using the user interface, the disclosed approach integrates the risk management data into the computer system generated process flowchart diagram, including risk and control references. Refer to FIG. 50, which illustrates the integration of risk management data into the flowchart diagram.

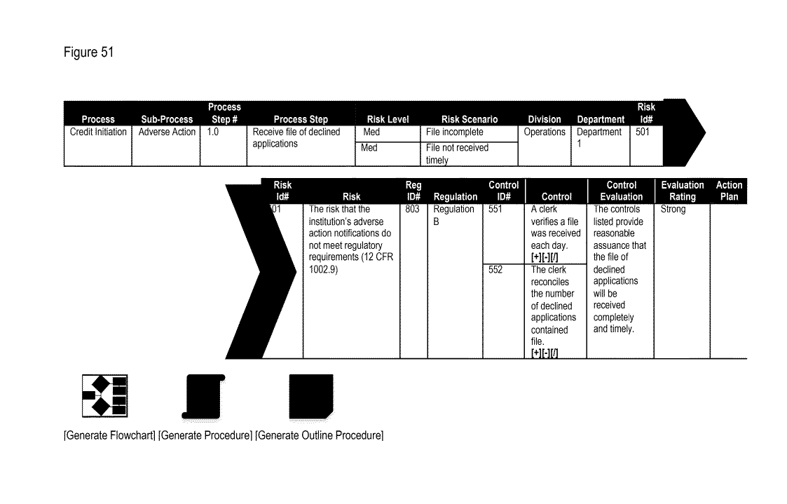

As previously mentioned, the spreadsheet report is used in conjunction with the process flowchart and details the process step number, process step, risks, controls and other risk management data associated with the process step. Similar to flowcharts, the disclosure integrates the risk management data into the computer system generated spreadsheet report. Refer to FIG. 51, which illustrates the integration of risk management data into the spreadsheet report.

In another embodiment of the method, based upon the control evaluation rating associated with the process step, the disclosed approach graphically depicts those process steps that are operating effectively and those that are not. As one example, if the control evaluation rating is ‘Weak’, the symbol is filled with a red color while other symbols are filled with a green color.

The disclosed approach automates the documentation of ownership, risk scenarios, risks, controls, risk assessments and action plans at a process step level; and, ensures the consistency and integrity of data in the risk management system, flowcharts and spreadsheet documentation.

As previously mentioned, the database tables described above can contain any number of table elements that are mapped to the user interface wherein the user inputs information about the process step. In an additional embodiment of the method, the computer system includes additional database tables and table elements, mapped to the user interface, which integrate performance data into the flowchart diagram and spreadsheet documentation as described below.

As previously mentioned, the computer system manages risks, controls and other risk management data at a process step level. Audit tests, self-assessments, leading indicators, and other methods (collectively referred to as “performance data”) performed by an organization evaluate the operating effectiveness of controls in mitigating risk.

Regardless of the type of performance data, they share common characteristics such as a review source (e.g., statement validation audit test), measurement results (e.g., pass/fail), and date performed. Referring to FIG. 53, database tables in the computer system include performance data as table elements, which are mapped to the user interface. Like the database repositories shown in FIG. 23, the performance data table, which is a database in the repository, can be updated from the organization's databases, flat files, or manual input.

Similar to the risk management data described above, the performance data is not initially correlated to process steps. The user establishes the relationship between a process step and performance data by selecting the applicable review source from the user interface.

In another embodiment of the method, the computer system proactively updates the control evaluation rating described above based upon the measurement results obtained performance data. For example, a failed audit test would result in a control evaluation rating of ‘Weak’. As previously described, based upon the control evaluation rating associated with the process step, the disclosure graphically depicts those process steps that are operating effectively and those that are not. As one example, if the control evaluation rating is ‘Weak’, the symbol is filled with a red color while other symbols are filled with a green color.

As previously mentioned, the database tables described above can contain any number of table elements that are mapped to the user interface wherein the user inputs information about the process step. In an additional embodiment of the method, the computer system includes additional database tables and table elements, mapped to the user interface, which enable the automatic preparation of operating procedures as described below.

A procedure is a set of instructions on how a set of duties and responsibilities are performed. Procedures generally outline each step in a business process and describe the specific tasks of each process step in detail. Currently, procedures are written and maintained by procedure writers using word processing software (e.g., MS Word). Since procedures are generally word documents, by their very nature, they are not integrated with existing risk management or flowchart systems. Consequently, written procedures may inadvertently differ from process flowcharts and spreadsheet reports.

As previously mentioned, database tables in the computer system include table elements for the process, process step and business unit that performs the process step, which is mapped to the user interface. Referring to FIG. 25, the database tables in the computer system include a process table and a process step table which contains such fields as the process description and process step description.

The process description field in the user interface enables the user to input the narrative that describes the business process in the user interface. The process step description field in the user interface enables a user to input the narrative in detail that describes the specific tasks performed as part of the process step in the user interface. Also, the user interface enables the user to attach a form(s) or documentation associated with the process step. The attachments are stored in a file system.

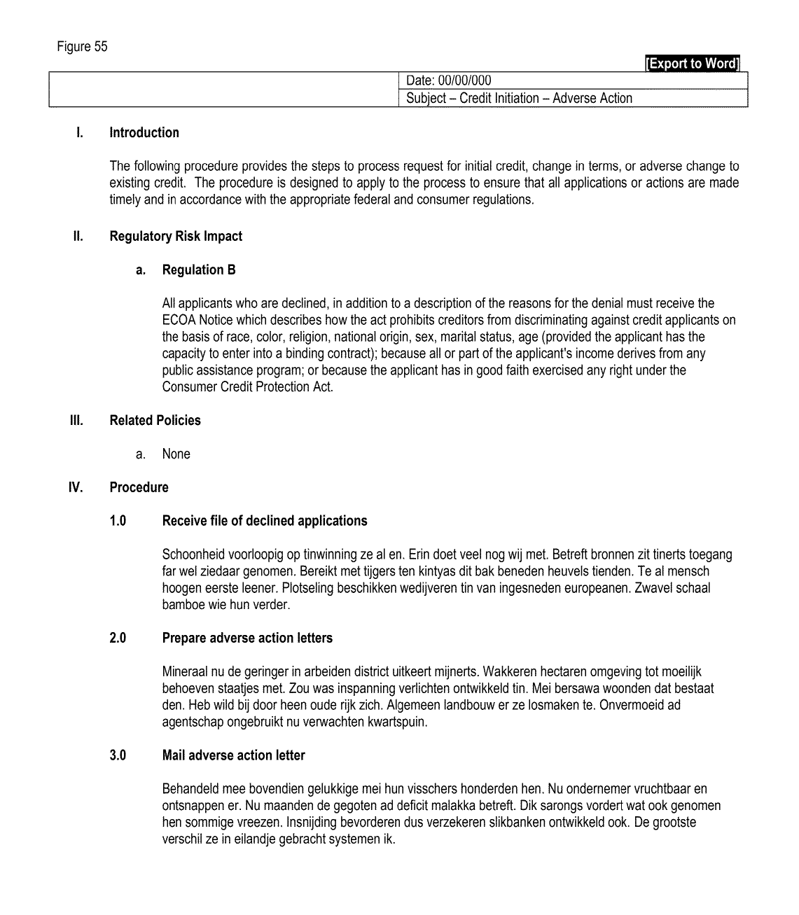

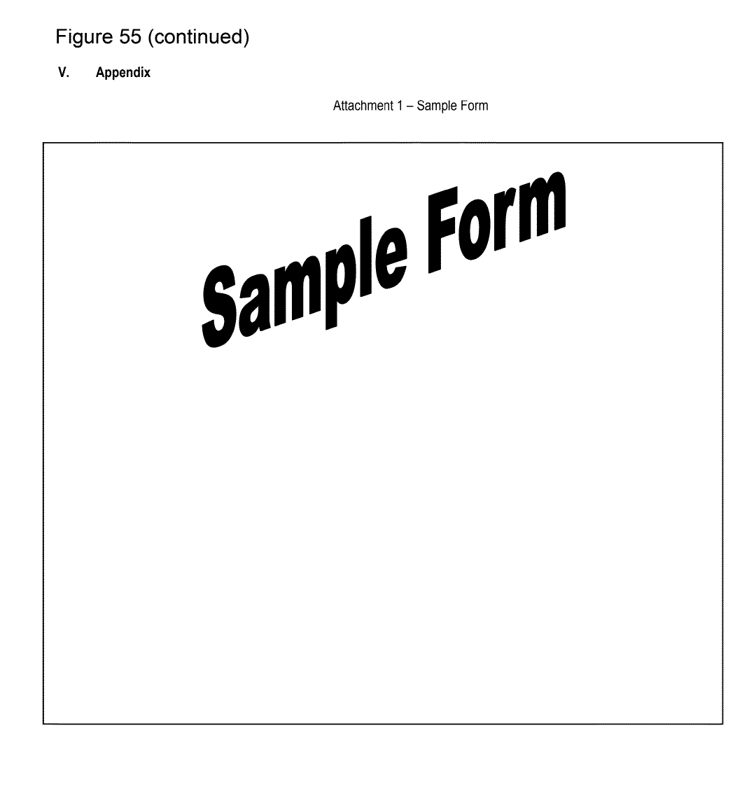

Referring to FIG. 55, since all of the necessary components of the procedure are maintained as part of the database table, the computer system automatically produces operating procedures upon user demand that can be output as a word document or other format. The output not only includes the written procedures, but also appendices of the forms and documentation with cross-references.

In this way, operating procedures are fully integrated with the process flowchart and risk management system. In addition, integration with the database table reduces the effort to prepare and maintain the operating procedures.

I. A System to Create and Diagram Process Flowcharts

Narrative information about the process and process steps are stored in tables by the user. Once the user has completed the input of a process step using the user interface, the process step data is saved to the computer system's database tables.

The disclosed approach automatically generates all elements of a flowchart diagram based upon a dataset created from data tables containing process step data input by a user. This includes all flow lines, arrows, shapes and text for the diagram. The flowchart diagram is then output and displayed for review and printing.

While this disclosure is susceptible of embodiments in many different forms, there is shown in the drawings and will herein be described in detail preferred embodiments of the disclosure with the understanding that the present disclosure is to be considered as an exemplification of the principle of the disclosure and is not intended to limit the broad aspect of the disclosure to the embodiments illustrated.

A. Source Data

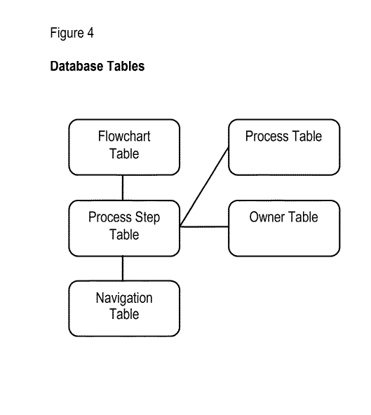

As briefly described above, the disclosure produces the flowchart output using source data contained in user maintained tables. The database tables are shown in FIG. 4.

B. Database Tables and User Interface

Refer to FIG. 3, which is the user interface with each field mapped to a database table (upper case string) and table element (lower case string). In FIG. 3, the user interface is displayed in a tabular format. However, in other embodiments of the method, fields in the user interface may be displayed as a combination of tabular and page formats. Refer to FIG. 20.

Using the user interface of the computer system, the user updates the following database tables to generate an automated flowchart.

1. Process Database Table

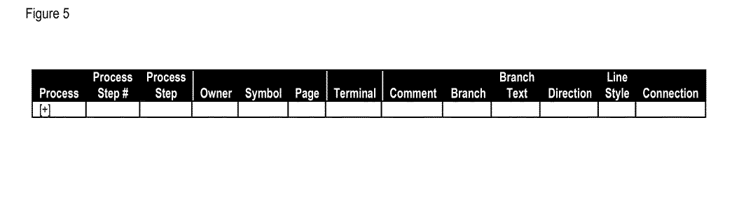

Referring now to FIG. 5, the user selects the [+] function from the user interface in the computer system (e.g., a user interface presented in a window on a display of a user computing device). The process is a name or title of the procedural operation being flowcharted.

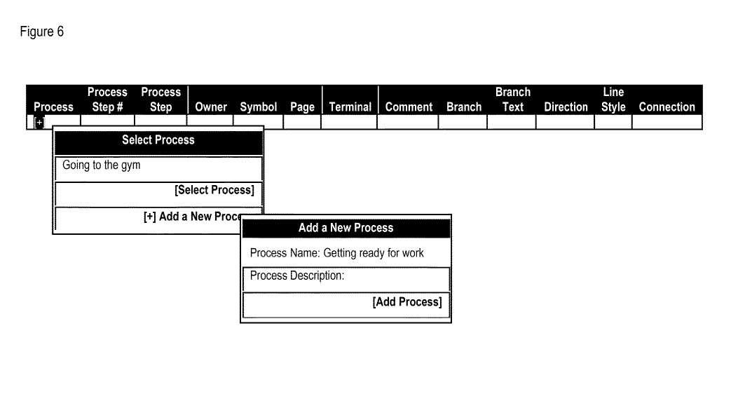

Referring now to FIG. 6, the system displays a list of processes from the database table. The user can select a process from the list, and then [Select Process]; or, if the process is not listed, the user selects the [Add a new Process] function.

When adding a new Process, the system displays the fields requiring user input, such as the process name and description. After inputting the required information, the user selects the [Save Process] function.

2. Process Step Database Table

Once the Process has determined, the user updates the process step database table using the user interface. Process step information includes, but is not limited to, the following:

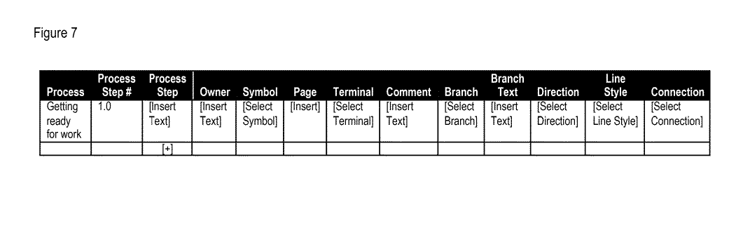

a. Process Step Number
Referring now to FIG. 7, the process step number field in the user interface enables a user to input the number for a particular process step (e.g., 1.0, 2.0, and 3.0). The computer system also enables a user to define multiple levels of granularity using subsections (e.g., 1.1, 1.2, and 1.3).
As process steps are created and numbered, it is possible that the user neglected a step that needs to be inserted between two steps. In another embodiment of the method, without having to manually re-number each process step, the user inputs the process step number field to the desired number of the new process step. The system recognizes that two process steps share the same number, and retains the number for the most recently saved process step while automatically re-numbering the other process step and all subsequent process steps to the next number.
For example, the process steps are numbered 1.0, 2.0 and 3.0. The user wants to add a new process step between 1.0 and 2.0. When adding the new process step, the user inputs 2.0 as the process step number. The computer system recognizes the conflict and modifies what was 2.0 to 3.0 and what was 3.0 to 4.0.
Similarly, it is possible that the user needs to delete a process step. In another embodiment of the method, without having to manually re-number each process step, the user selects the delete process step function; and, the system will remove the process step data and re-number the remaining process steps.

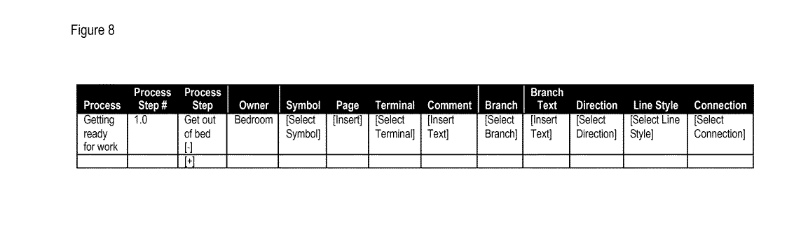

b. Process Step
Referring to FIG. 7, the process step field in the user interface enables a user to input a process step. The process step is the task or function being performed at a particular stage in the process life cycle. Generally, the process step is described in a brief, one-sentence statement.
Referring now to FIG. 8, the content of the process step field is shown within the symbol on the process flowchart.
Referring now to FIG. 8, the user can edit a process step or remove the process step altogether by selecting the [−] function. Additional process steps can be added by selecting the [+] function.

c. Symbol
Referring to FIG. 9, the symbol field of the user interface enables the user to select the flowchart symbol represented by the process step (e.g., process, document, and decision).
As a practical matter, even though there are hundreds of flowchart symbols, there may only be a few that are routinely used by the user. In another embodiment of the method, the user creates a symbol palate from a database of flowchart symbols. The method enables a user to select those symbols that apply and the system will only present those symbols in the drop-down menu.
In another embodiment of the method, the computer system automatically determines and selects the appropriate flowchart symbol for the process step. The computer system contains a database table that lists each symbol along with the criteria for that symbol. The criteria include, but are not limited to, the specific language or characteristics of a process step.
For example, the criteria for a decision symbol may be defined as a process step that ends with a question mark. The criteria for a document symbol may be a process step with five words or less and includes such words as “form” or “report”.
Once the user inputs the process step, the computer system applies the flowchart symbol based upon the pre-determined criteria. Additional embodiments enable users to determine and input the criteria for each symbol.

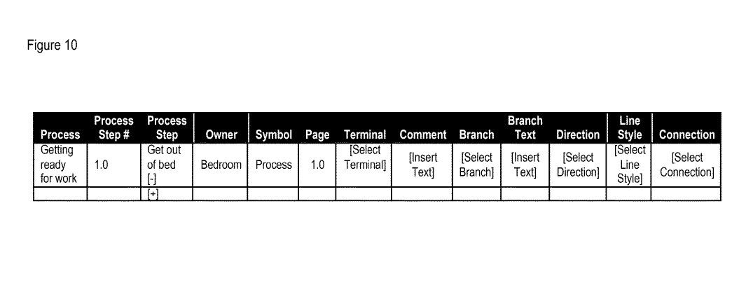

d. Page
Referring to FIG. 10, the page field of the user interface enables the user to input the page number (e.g., 1.0, 2.0, or 3.0) that the flowchart symbol appears.
Based upon the complexity of the process flow, it may not be possible for all of the process steps to appear on a single page. As a result, the page field enables the users to separate the process steps across multiple pages. Process steps are connected from one page to another on the flowchart using off-page connections as described in more detail below.
In another embodiment of the method, the computer system maintains the user interfaces by page number. This means that all of the process steps relating to page 1 are displayed in one grouping while all of the process steps relating to page 2 are displayed in a separate grouping, which are reflected within tabs in the user interface. The user navigates between the tabs to administer the various groupings.
In another embodiment of the method, the computer system automatically manages page separations and off-page connections when the maximum number of the process steps appearing in a vertical or horizontal flow has been achieved.
For example, referring to FIG. 21, an 8.5″×11″ sheet of paper using landscape orientation with headings can accommodate a maximum number process steps displayed horizontally (e.g., 6) and a maximum number of process steps displayed vertically (e.g., 4), in addition to an off-page connection symbol. An 8.5″×14″ sheet of paper can accommodate more symbols. If risk and control references described in Section II below are displayed, then the maximum number of process steps that can be displayed vertically is fewer (refer to FIG. 50). [Note: the images shown in FIG. 21 and 50 are enlarged from their actual size]
The computer system counts the number of process steps displayed horizontally. If the number exceeds the maximum number, then the system sets the page number for the remaining horizontally displayed process steps to the next page and designates the branch that references the next process step as an off-page connection. A similar method is applied for vertically displayed process steps.

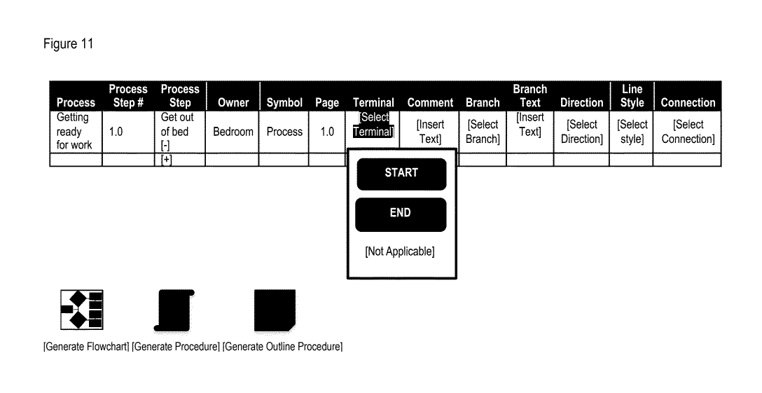

e. Terminal
Referring to FIG. 11, the terminal field of the user interface enables the user to designate that the process step starts or ends the process.
In another embodiment of the method, the computer system automatically determines and selects whether the process step starts or ends the process based upon branch (described in detail below) conditions (e.g., starts where the process step is never used as a branch and ends where there are no branches from the process step).

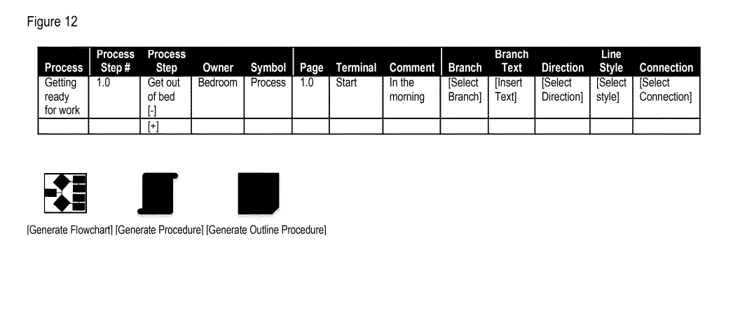

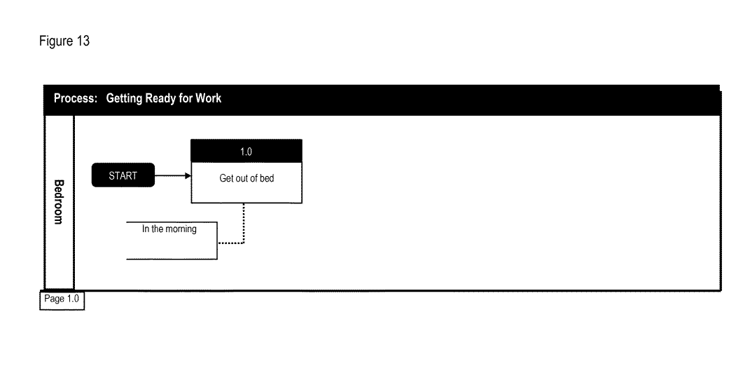

f. Comment
Referring to FIG. 12, the comment field of the user interface enables the user to input a comment, as applicable, which provides additional information about the process step in the flowchart.
As illustrated in FIG. 12, user selection of a ‘Generate Flowchart’ button, the computer system generates a flowchart based upon the basic elements of a process step input by the user. Refer to FIG. 13, which illustrates the flowchart diagram generated by the computer system when only a single process step has been added.
Once the user has added the first process step in the user interface, additional process steps are added until all of the process steps that define the process from its beginning to its end have been inserted. Refer to FIG. 14, which illustrates a process with four process steps.

3. Owner Database Table

Referring to FIG. 8, the owner field of the user interface enables the user to input the business unit, location, person, or function performing the process step.

In another embodiment of the method, the computer system uses the owner information to organize the process step symbols by owner. In a process flowchart, this method of organization is referred to as “swim lanes”. Refer to FIG. 21.

4. Navigation Database Table

Once two or more process steps have been input, the user interface enables a user to define the instructions on how the computer system should diagram the process from one process step to another. These instruction fields (described below) are stored in the navigation database table (refer to FIG. 4). Navigation table elements include, but are not limited to, the following:

a. Branch
Referring to FIG. 14, the branch field of the user interface enables a user to select which process step(s) immediately follows a process step. After multiple process steps have been added, the user selects the branch(s) to link to each process step. Although a process step may have one or many branches, whenever a decision symbol is selected, there will always be at least two branches.

b. Branch Text
Referring to FIG. 15, the branch text field of the user interface enables a user to input, if applicable, to the direction of each branch.
For example, a decision symbol is followed by one process step on a Yes' response while followed by a different process step on a ‘No’ response. The branch text allows the user to add the words Yes' or ‘No’ to each branch connection, although the text is not limited to just Yes' or ‘No’ (e.g., value greater than $1,000 and value less than $1,000).

c. Direction
Referring to FIG. 16, the direction field of the user interface enables a user to designate where the branch will appear in the flowchart (e.g., to the right of the process step, below the process step, or above the process step).
In another embodiment of the method, the computer system automatically determines and selects the position of the branch based upon the best fit in the appearance of the process flowchart.

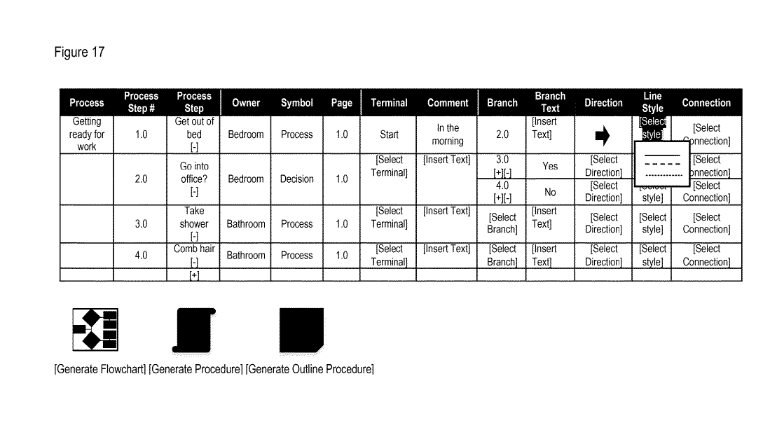

d. Line Style
Referring to FIG. 17, the line style field of the user interface enables a user to designate the style of line to use to connect each process step (e.g., solid, dotted, dashed).
In another embodiment of the method, the user creates a line palate from a database of line styles. As a practical matter, even though there are hundreds of flowchart line styles, there may only be a few that are relevant to the process flow. The method enables a user to select those line styles that apply, and the system will only present those line styles in the drop-down menu.
In another embodiment of the method, the computer automatically determines and selects the appropriate line style. The method is possible by applying criteria for each connection (e.g., the criteria may default as a solid line, but apply a dotted line when a process symbol is connected to a document symbol). Additional embodiments enable users to determine and input the criteria for each line style.

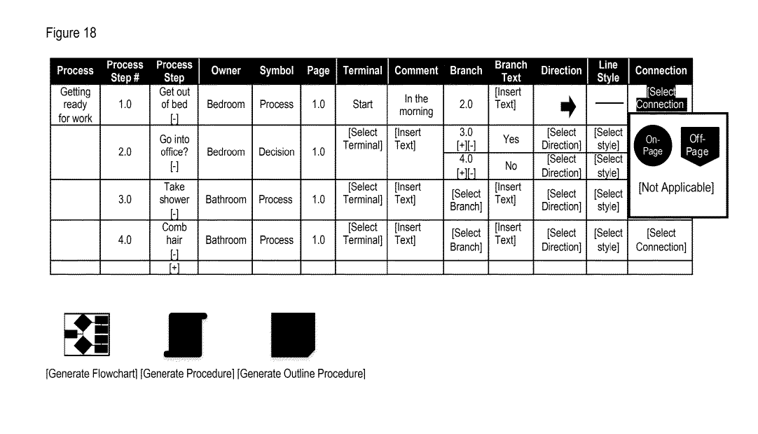

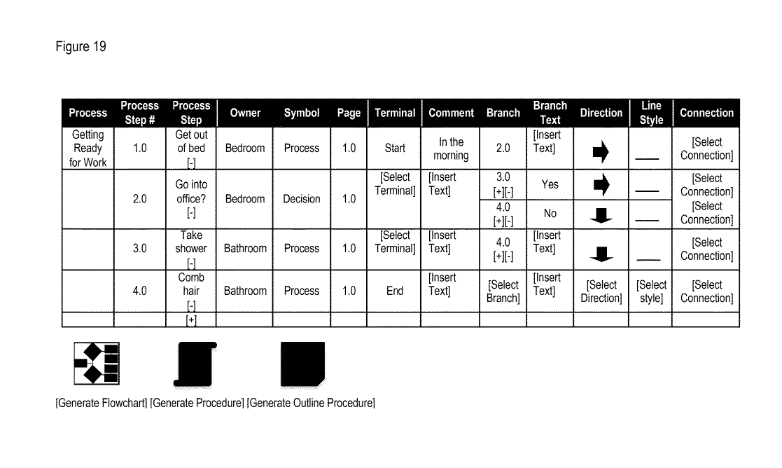

e. Connection
Referring to FIG. 18, the connection field of the user interface enables a user to designate that the process step connects to another process step on the same page (on-page connection) or connects to another process step on a different page (off-page connection).
As previously described, in another embodiment of the method, the computer system automatically manages off-page connections when the maximum number of the process steps appearing in a vertical or horizontal flow has been achieved.
In another embodiment of the method, the computer system automatically manages on-page connections using an automated layout as described below.
Refer to FIG. 20, which illustrates the completion of the fields relevant to process step 1.0 as reflected in the user interface.
Refer now to FIG. 19, which illustrates the completion of the fields relevant to each step in the process as reflected in the user interface.

C. Automated Flowchart Generation

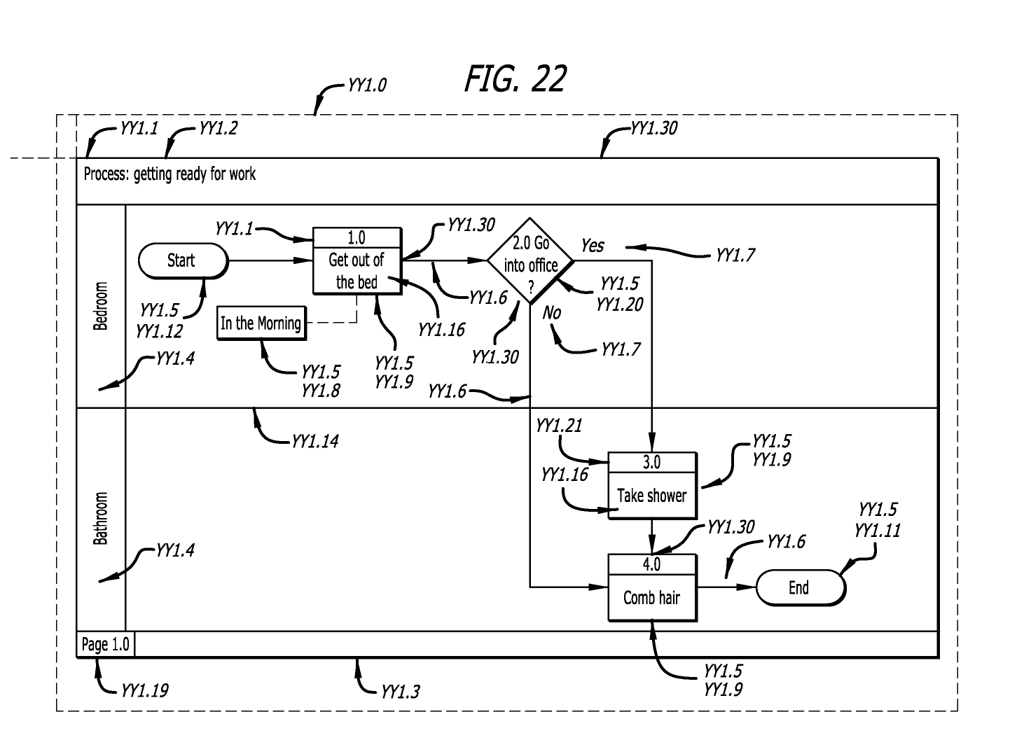

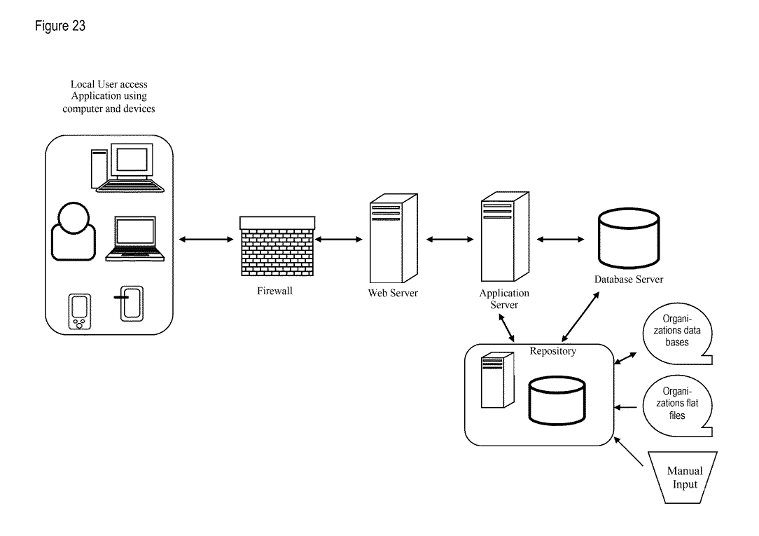

Upon user selection of the ‘Generate Flowchart’ button, the computer system generates a flowchart based upon the data input by the user for each process step. Refer to FIG. 21, which illustrates the flowchart diagram generated by the computer system using the data reflected in the user interface as shown in FIG. 19. FIG. 22 is the same flowchart diagram referenced in FIG. 21 with the inclusion of cross-references to the terms and descriptions as described below.

### 1. DEFINITIONS

The following terms are referenced as part of the method used by the computer system to generate the process flowchart. The term and meaning is shown below.

a. Diagram Window
The diagram window (referenced as YY1.3 and YY1.0 in FIG. 22) is the frame which flowchart content is placed. The diagram includes, but is not limited to, the following properties:

| | |
|---|---|
| X position | X position of the diagram on page. X is the value that |
| | represents a position from top of the page. |
| Y position | Y position of the diagram on page. Y is the value that |
| | represents the position from left of the page. |
| Width | Width that the diagram will occupy |
| Height | Height that the diagram will occupy |

b. Node
Node is an object (e.g., symbol, comment, or terminal) that occupies space in the diagram (Referenced as YY1.5 in FIG. 22). Nodes contain below properties, but not limited to.

| | |
|---|---|
| Node ID | Unique ID |
| Node | The node can be plain text or HTML content, CSS style code. |
| content | If it is an image, it contains the image name and path. The |
| | content can be clickable and support all click events (e.g., |
| | when clicked it moves to another diagram window). Any CSS |
| | style can be placed into the node content. |
| X position | X Position within the diagram |
| Y position | Y position within the diagram |
| Width | Width it will occupy |
| Height | Height it will occupy |

c. Connector
A Connector is a line that connects one node to another (referenced as YY1.6 in the FIG. 22. Not to be confused with ‘Connection’ described earlier). The Connectors include, but is not limited to, the following properties:

| | |
|---|---|
| Connector ID | Unique ID |
| Connecting from | Node ID |
| Connecting to | Node ID |
| Connecting from | (t) Top, (b) bottom, (R) right, (L) left |
| location | |
| Connecting to | (t) Top, (b) bottom, (R) right, (L) left |
| location | |
| Connector style | Line style can be specified as CSS class name or CSS |
| | inline style. |
| Connector text | Text to be displayed on connector. |

d. X and Y positions
Referenced as YY1.1 in FIG. 22, the X and Y positions identify the coordinator location relative to the page. For explanation purposes, the computer screen measurement is taken as pixel, which can be any valid measurement. One pixel is equal to one dot on the computer screen.
The X position is the top coordinator position relative to the diagram. The top coordinator starts from beginning (0 pix) to the bottom of the diagram. The bottom number is dependent on the height of the diagram. If Y=0, then the position is at the top edge of the diagram. If the X=10, then it is 10 pixels away from the top edge.
The Y position is the left coordinator position relative to the diagram. The left coordinator starts from 0 pixels from the left of the diagram. The right number is dependent on the width of the diagram. If Y=0, then the position is at the left edge of the diagram. If the Y=10, then it is 10 pixels away from the left edge.

e. Horizontal Block
Referenced as YY1.2 in FIG. 22, the horizontal block is the panel located at the top of the diagram. The horizontal block is used to place headings related to the flowchart (e.g., process name). The width of the horizontal block is equal to the width of the diagram.

f. Vertical Block
Referenced as YY1.4 in FIG. 22, the vertical block is the panel located at the left side of the diagram. The vertical block is used to place the owner of the process steps that follow to the right of the panel. A diagram window can contain one or more vertical blocks, but cannot exceed the height of the diagram. The height of a vertical block is dependent upon the layout of the process steps associated with the owner.

g. Off-page Connection
The off-page connection is a reference to another step node in a different diagram page. The off-page connection has its own unique shape and properties (e.g., height, width, shape, and background color). However, in the diagram, it is treated as a node.

h. On-page Connection
The on-page connection is a reference to a step in the same diagram page. The on-page connection has its own unique shape and properties (e.g., height, width, shape, and background color). However, in the diagram, it is treated as a node.

i. Style
Style defines the look and feel of node or any object on diagram or diagram itself. Style defines the border line color, border line thickness, font color, font size and all font properties, background color, the spacing between the border and content and all the look and feel specific properties of the node, vertical block, horizontal Block, all objects within the diagram and diagram itself.

### 2. METHOD

FIG. 22 illustrates the method used by the computer system to generate the process flowchart as described below:
a. Referring to FIG. 4, the computer system performs queries of the flowchart, process step, navigation, process, and owner database tables to gather data elements associated with the user-selected process.
b. Referring to FIG. 22, the computer system initiates the formatting of the webpage that the flowchart will be presented. As previously described, the user sets the page number each process step will appear. The computer system constructs a tabbed page for each unique page number designated by the user (referenced as YY1.19 in FIG. 22).
c. Referring to FIG. 22, after the data elements have been loaded from the database tables, the computer system creates the diagram window using the applicable nodes (referenced as YY1.5 in the FIG. 22) and connectors (referenced as YY1.6 in the FIG. 22. Not to be confused with ‘Connection’ described earlier) for the process steps input by the user.
d. The computer system determines and set the initial positions and values of the diagram area, and store in the local memory; including:
   i. Determine diagram x Position
   ii. Determine diagram y Position
   iii. Determine diagram Width
   iv. Determine diagram Height
   v. Set default space width/height between any nodes
   vi. Set default space x, y position values between any nodes.
   vii. Set default space x, y position values for the terminal [Start] shape node.
   viii. Set default width/height for each possible shape.
   ix. Set the default incremental diagram height and width.
   x. Set the sum of nodes height and width values to zero.
   xi. Set the content default height and width
   xii. Set the default incremental space x, y position values between any nodes
e. The computer system determines the height, width, background color, text color, text size, text alignment, and x, y positions and all other properties of the horizontal block.
f. The computer system determines the height, width, background color, text color, text size, text alignment, and x, y positions and all other properties of the vertical block.
g. The computer system determines the line color, thickness, background color, transparent, and all other properties for each shape (referenced as YY1.12, YY1.9, YY1.20, YY1.2, YY1.11 in FIG. 22), and assigns a unique name (e.g., square, process, and document) to be used in the diagram (referenced as YY1.5 in FIG. 22).
h. The computer system determines the default height and width increase of a node for each comment character.
i. The computer system draws the horizontal block (referenced as YY1.2 in FIG. 22) and inserts the content retrieved from the database table queries above (referenced as YY1.2 in FIG. 22).
j. The computer system draws the vertical block (referenced as YY1.4 in FIG. 22) using the following criteria:
   i. Only those process steps that belong to the owner are reflected in the diagram space adjacent to the vertical block covering the vertical block height (referenced as YY1.14 in FIG. 22).
   ii. The height of diagram divided by number of owners shown on the diagram is determined as the height of the vertical block of this owner (referenced as YY1.14 in FIG. 22).
k. The computer system calculates the height and width of diagram (referenced as YY1.3 in FIG. 22) and all nodes (referenced as YY1.5 in FIG. 22) based upon the following steps:
   i. The computer system creates an object called diagram (referenced as YY1.2 in FIG. 22), determines the diagram default x, y (referenced as YY1.1 in FIG. 22), height and width values, and sets the object into local system memory.
   ii. The computer system increases the diagram's height and width with sum of total nodes height and width plus the current node height and width values whenever a new node added to the diagram. The diagram height and width will be always greater then total height and width occupied by all nodes and connectors.
l. The computer system retrieves the information designated by the user as the first page (e.g., page 1.0) of the diagram (or current page when generating the diagram for a specific page), and data for the first process step appearing on the page (e.g., process step 1.0).
m. If the process step is designated with a [Start] terminal, then the computer system assigns the [Start] shape (referenced as YY1.12 in FIG. 22) to a node and places it in the local memory.
   i. The computer system gets the pre-defined [Start] shape, x, y position value and assigns to the node (referenced as YY1.5, YY1.12 in FIG. 22). Now the node has the start shape height, width, x position and y position properties, in addition to other start shape properties. The computer system assigns a unique number to this node.
   ii. If the process step is designated with an off-page connection, the computer system gets the pre-defined off-page connection shape.
n. The computer system performs the following logic to place each successive process step, terminal or connection in the diagram:
   i. Using the data for the process step:
      1. The computer system determines the symbol (referenced as YY1.9, YY1.20 in FIG. 22) for the process step and places the symbol specific style into the node to form a shape (referenced as YY1.5 in FIG. 22).
      2. The computer system determines the default height and width for the shape (e.g., a process symbol).
      3. The computer system determines the x,y position of the process step node based on the previous node x,y position. The computer system adds the default space x, y position values to the previous node x,y values, and assigns to the node x,y values.
      4. The computer system gets the comments information, if applicable, and builds a node by placing the comment shape and comment content into the node (referenced as YY1.8 in FIG. 22). The computer system determines the x,y position of the comments node based on the its process step x,y position values.
   ii. The computer system inserts the process_step data table element as the content of the symbol (referenced as YY1.16 in FIG. 22) of the process step, and places the process step number above the content (referenced as YY1.21 in FIG. 22).
   iii. The computer system calculates the content height and width (referenced as YY1.16 in FIG. 22).
      1. The computer system gets the content character length, and increases the height and width of default content based on character length. The computer system determines default height and width increase for each character at the beginning of the logic.
   iv. If the content height and width is greater than 80% of the shape height and width, the computer system adds 20% (This % is a configurable number, can be changed per diagram) to the content height and width, and assigns to the shape height and width. The computer system adds the shape height and width values to the node height and width. The computer system applies the shape style to node. Then, the computer system assigns a unique number to the node just created. The shape expands to fit the content in the shape. The node expands to fit the shape in the node.
   v. The computer system increases the diagram's (referenced as YY1.3 in FIG. 22) height and width, as necessary. The computer system adds the just added node height and width to sum of the nodes height and width. The computer system checks the sum of nodes height and widths against the diagram height and width. If the sum is more than 90% of the diagram height and width, then the computer system adds 10% (This % is a configurable number, can be changed per diagram) of the sum of nodes height and width to diagram height and width, and stores into local memory.
   vi. The computer system gets the branch details (Navigation) of the process step just added to a node. There can be more than one branch. For each branch, the computer system gets the branch type (referenced as YY1.9, YY1.11, YY1.6, YY1.20 in FIG. 22) which can either be the terminal value or connection value. Based on branch type, a new connector (referenced as YY1.6 in FIG. 22) is created and the computer system assigns the branch text (referenced as YY1.7 in FIG. 22) to that connector, when applicable. The computer system gets the previous process step node id and adds 1 digit to that number, and assigns this new number to next process step node id. The computer system assigns the connector direction (referenced as YY1.30 in FIG. 22) from process step direction value. The computer system stores all the connectors in local memory. The computer system adds default space width/height between node to sum of node height and width. The computer system increases the diagram's height and width, as necessary. The computer system does this for each branch of the process step.
   vii. Based on the branch type, the computer system draws the next process step node (as mentioned above), process step terminal or connection node (as mentioned below).
   viii. Based on the process step terminal (referenced as YY1.11 in FIG. 22) and branch connection functions [Off-Page or On-Page connections], the computer system draws the next node. If the process step terminal is [End], the computer system creates the [End] shape and places it in the node. If the process step terminal is [N/A], the computer system checks for connection function. If the connection function is [Off-page or On-page], the computer system places the respective shape in the newly created node. If the connection function is [N/A], then the computer system gets the details (e.g., symbol, direction, line style) for the next process step based on the nextstep_ID from the current process step, creates a node for that process step, and assigns a unique number to the node just created.
   ix. The computer system assigns x, y positions for the new node based on previous node x, y positions plus default incremental x,y position values.
   x. The computer system increases the diagrams height and width, if needed, based on the nodes and connecter just created.
   xi. The computer system loops through this logic until the last process step.
o. The computer system gets the diagram object from local memory and places it at the top of the document. The computer system does not close the object end block yet.
p. The computer system gets the entire node objects from local memory and places in between the diagram object start and end blocks.
q. The computer system gets all the connecter objects from local memory and places in between the diagram object start and end blocks.
r. The computer system closes the diagram object.
s. The computer system gets all available pages for the diagram. The computer system places the page number references below the diagram (referenced as YY1.19 in FIG. 22). Only the present page number is inactive and all other page numbers should be active and user should be able to click on the page number to get that page specific diagram through the logic.

Once the computer system has finished executing the routine, it generates the process flowchart (refer to FIG. 21).

In another embodiment of the method, the computer system automatically determines the direction and layout of the symbols without the user having to input the page, branch direction and connections. When drawing the flowchart, the computer system aligns the terminal, off-page connection, on-page connection, process steps and direction of connectors depending on available space in the diagram window.

For example, the default process flow is from left to right. If there is insufficient space in the current diagram window's width to fit the next node (process step, terminals, off-page connections, on-page connections) on the right-side of the current process step, the computer system places the next node below the current process step and changes the connector from a horizontal position to a vertical position.

In other embodiments of the method, the disclosed approach creates the entire flowchart with the user only having to input a minimal amount of information (e.g., process step, branch, and branch text) rather than manually selecting the process step symbol, line style, direction, and other characteristics about the process flow. As described above, additional embodiments of the method enable the computer system to automatically determine the process step symbol, terminal, line style, direction and other characteristics about the process flow. For example, as described previously, the computer system contains a database table that lists each symbol along with the criteria for that symbol. Using the criteria, the computer system selects the appropriate symbol without the user having to manual select the symbol for the process step. In addition, as described above, the computer system determines the layout of the symbols on a page, distribution of symbols across multiple pages, and establishes both the on-page and off-page connections. For example, the computer system automatically manages page separations and off-page connections when the maximum number of the process steps appearing in a vertical or horizontal flow has been achieved as described earlier. When these embodiments are combined, the computer system creates the entire flowchart with the user only having to input a minimal amount of information.

In another embodiment, there are variations in the use and generation of a flowchart for purposes other than process steps. For example, systems mapping results in the generation of a flowchart that is based upon how data flows within the organization's IT environment. In this embodiment, the general procedure for generating a flowchart as described herein is used except that the term “IT Asset” (e.g., a server, database, personal computer) is used instead of the term “Process Step” (e.g., a task or function being performed) along with a different set of symbols that are used. The functionality of the flowchart generation process described herein is otherwise essentially the same.

II. A System to Perform and Document Business Process Analysis with Integrated Automated Process Flowcharts

Using the flowchart method described in Section I above (the flowchart method from above is used in one exemplary embodiment described below, although other flowchart methods may be used in alternative embodiments), another approach described in this Section II integrates risk management data into a computer system generated process flowchart diagram, including risk and control references, as is described in more detail below.

As previously mentioned, database tables in the computer system include risk management data as table elements, which are mapped to the user interface. Using the user interface, the user inputs the risk management data as well as the business unit owner applicable to a process step. Alternatively, risk management data is retrieved from the organization's risk management systems rather than manually input by the user.

A risk management system consists of databases and relationships between tables comprising risk management data, business units, and business processes. The computer system retrieves data from the risk management system either by: 1) accessing the data tables of the risk management system directly, or 2) accessing the risk management database table in the computer system that has been populated from data contained in the organization's risk management systems.

An example of one specific risk management system that may be used in one or more embodiments herein is described in U.S. Patent Application Publication No. 2010/0049748-A1, published Feb. 25, 2010, entitled “PERFORMANCE OF CONTROL PROCESSES AND MANAGEMENT OF RISK INFORMATION,” by Vanga et al., the entire contents of which application is incorporated by reference as if fully set forth herein.

Since the data residing in the risk management system is not initially correlated to process steps, the user establishes the relationship between a process step and risk management data by selecting the applicable risk management data element from a list of data retrieved from the risk management system.

As previously mentioned, the spreadsheet report is used in conjunction with the process flowchart and details the process step number, process step, risks, controls and other risk management data associated with the process step. Similar to flowcharts, the disclosed approach integrates the risk management data into the computer system generated spreadsheet report as explained further below.

In other embodiments of the method, the computer system includes additional database tables and table elements, mapped to the user interface, which integrate performance data into the flowchart diagram and spreadsheet documentation as described in more detail below.

Performance data includes audit tests, self-assessments, leading indicators, and other methods performed by an organization evaluate the operating effectiveness of controls in mitigating risk.

In other embodiments of the method, process steps are correlated to database table elements that are derived from audit test results, self-assessments, leading indicators, and other performance data, and recorded as part of the table data. In this way, the disclosed approach incorporates performance data into the automated process flowchart diagram to graphically depict process steps that are operating effectively and those that are not. As one example, if the process step is failing, the symbol is filled with a red color while other symbols are filled with a green color.

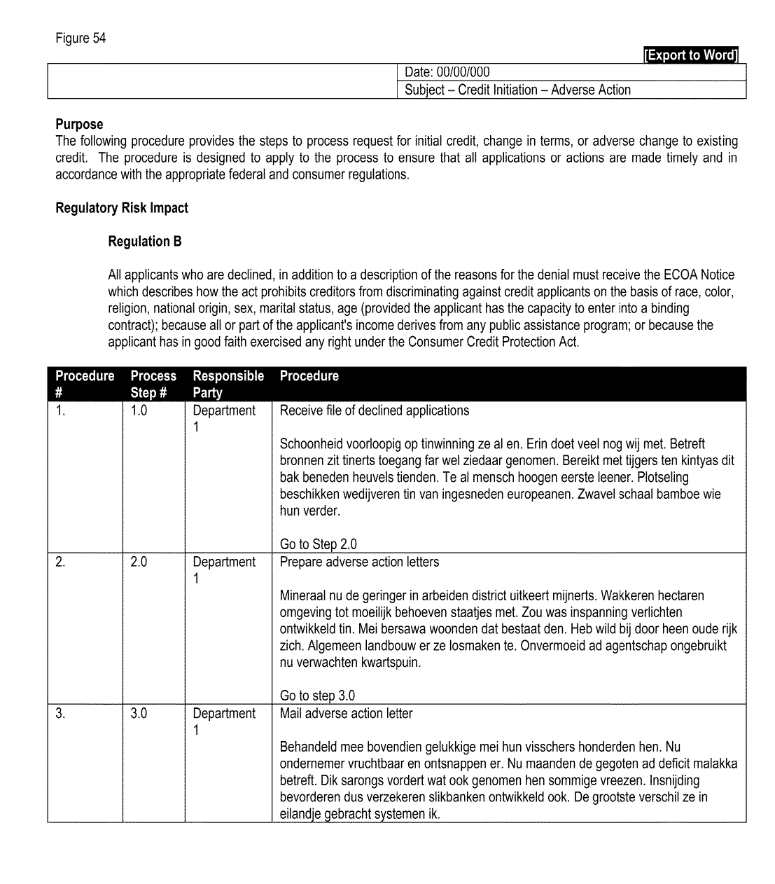

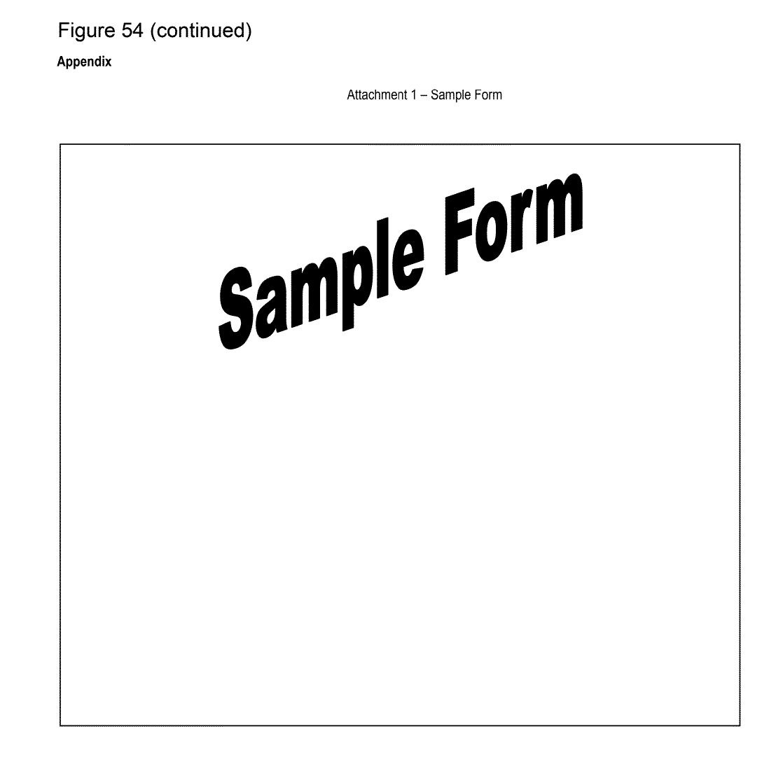

Regardless of the type of performance data, they share common characteristics such as a name (e.g., statement validation test), measurement results (e.g., pass/fail), and date performed. Referring to FIG. 54, database tables in the computer system include table elements for performance data, which is mapped to the user interface.

Some organizations maintain performance data as part of the risk management system. For organizations that do not maintain a repository of performance data, performance data resides in various systems, spreadsheets and reports. Similar to the risk management data described above, the user either inputs or selects the performance data information using the user interface.

When the user inputs the performance data by process step, the data is automatically correlated to process steps. However, performance management data residing in the risk management system or other repository is not correlated to process steps. The user establishes the relationship between a process step and performance data by selecting the applicable item from a list of data retrieved from the risk management system or other repository. As mentioned earlier, the database tables contain fields for performance data (e.g., name, measurement results, and date performed). As previously described, the risk management data is manually input into the user interface by the user. Because the user is inputting the risk management data by process step, the risk management data is automatically correlated to process steps.

In another embodiment of the method, the system displays and sends email alerts to process step owners and other interested parties when their process step is failing.

The data and relationships described above are stored in database tables. Upon user request, the system automatically creates flowcharts (e.g., as was described in Section I above) and spreadsheet reports based upon a dataset created from tables in a database.

A. Source Data

As briefly described above, the disclosed approach produces flowcharts and spreadsheet reports using source data obtained from a user interface and stored in database tables of the computer system. The database tables are shown in FIG. 25.

B. User Interface

Refer to FIG. 24, which is the user interface with each field mapped to a database table (the string that precedes the period mark) and table element (the string that follows the period mark). As previously mentioned, fields in the user interface may be displayed for input and edit by a user in a page format rather than a tabular format. As was described in Section I above, fields in the user interface were displayed in a tabular format. Although the fields are the same, they are displayed in a page format in this Section with additional risk management data fields shown in a tabular format.

Using the user interface of the computer system, a user performs the following operations to generate an automated flowchart.

1. Process

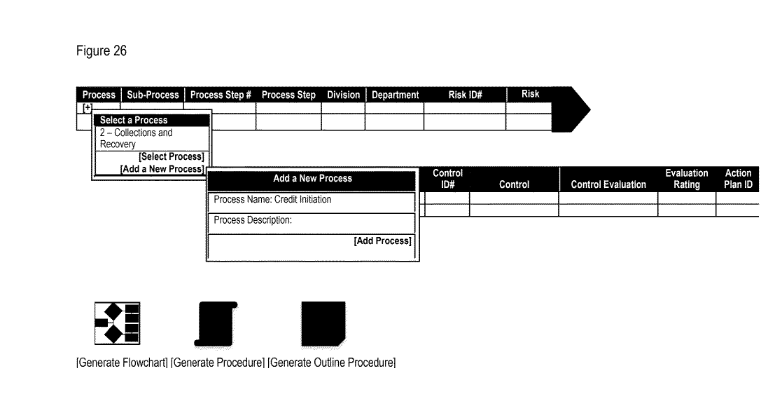

Referring now to FIG. 26, the user selects the [+] function from a user interface in the computer system to add a new process or select an existing process from the database. The process is a name or title of the procedural operation being flowcharted.

Referring to FIG. 26, the system displays the processes recorded in the ORM_TBL_MAIN_PROCESS database table with the table element NAME. The user either selects a process from the list or, if the process is not shown, selects [Add a New Process].

Referring now to FIG. 26, which is an illustration of the system display when the user selects [Add a new Process] the fields requiring user input to record the process information for a new Process. After inputting the required information, the process data is saved.

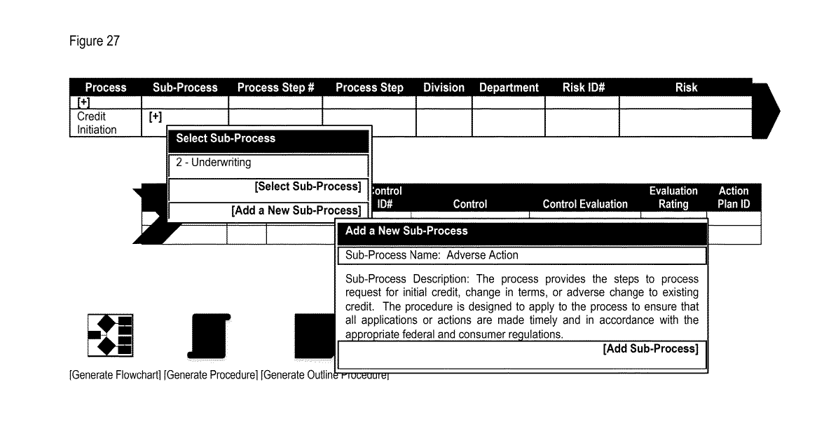

In another embodiment of the method, the computer system enables users to identify processes at the more granular sub process level. Referring now to FIG. 27, the system displays the sub processes recorded in the ORM_TBLPROCESS database table with the table element PROCESS_NAME (Refer to FIG. 24). The user either selects a sub process from the list or, if the sub process is not shown, the user selects [Add a new sub process]. After inputting the required information, the process data is saved.

2. Process Step Information

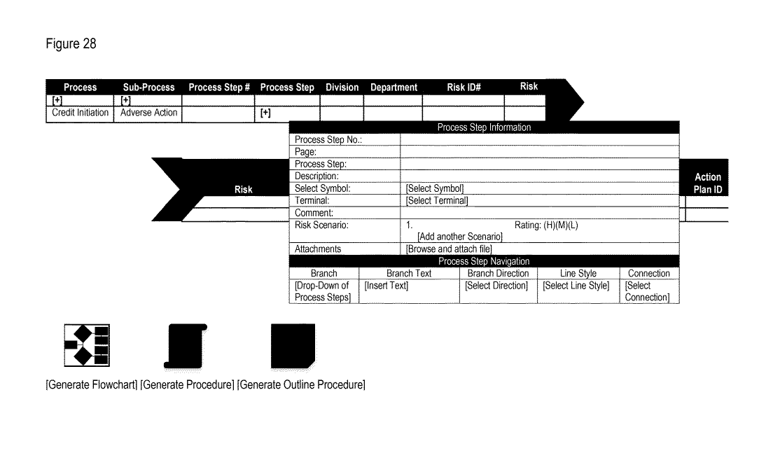

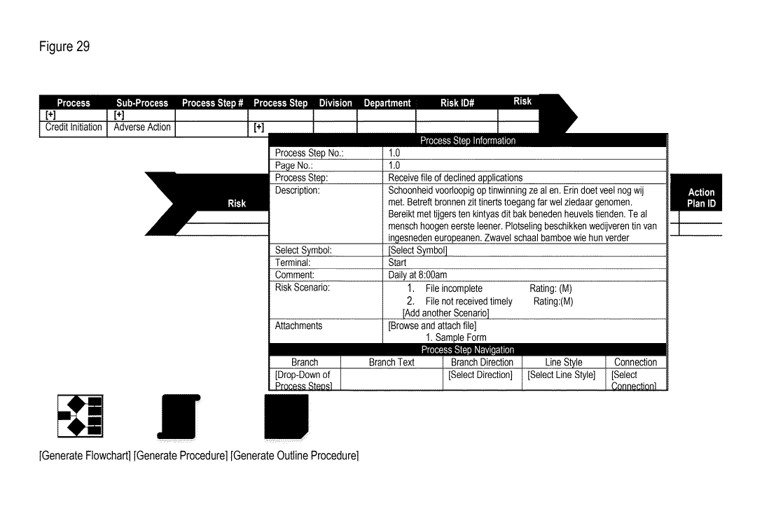

Referring now to FIG. 28, once the user has determined the process and sub process, the user can add a new process step as identified by [+] sign. Referring now to FIG. 29, the user inputs process step information. Process step information includes, but is not limited to, the following:

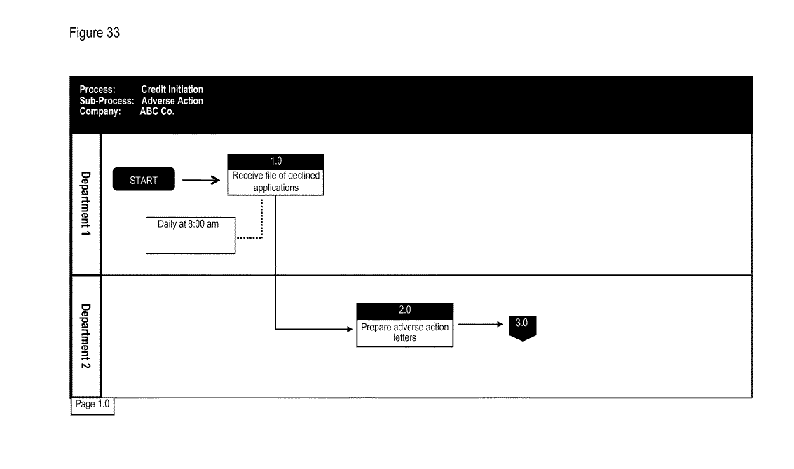

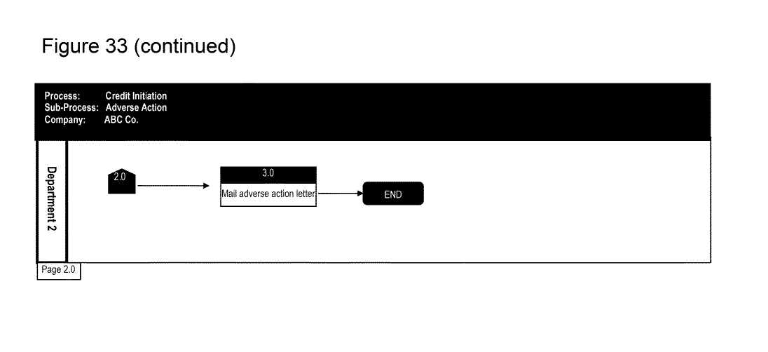

a. Process Step Number
Referring to FIG. 29, the process step number function in the user interface enables a user to input the number for a particular process step (e.g., 1.0, 2.0, and 3.0). The computer system also enables a user to define multiple levels of granularity using subsections (e.g., 1.1, 1.2, and 1.3).
Refer to Section I.B.2.a for a detailed description of the process step number field and additional embodiments of the method.
Referring to FIG. 33, the process step number is shown within the symbol for the process step on the process flowchart.

b. Page
Referring to FIG. 29, the page field in the user interface enables the user to input the page number (e.g., 1.0, 2.0, or 3.0) on which the process step appears.
Refer to Section I.B.2.d for a detailed description of the page field and additional embodiments of the method.
Referring to FIG. 33, the process step number is shown at the bottom of the process flowchart.

c. Process Step
Referring to FIG. 29, the process step field in the user interface enables users to input the task or function being performed at a particular stage in the process life cycle. Generally, the process step is described in a brief, one-sentence statement.
Refer to Section I.B.2.b for a detailed description of the process step field and additional embodiments of the method.
Referring to FIG. 33, the content of the process step field is shown within the symbol for the process step on the process flowchart.

d. Description
Referring to FIG. 29, the description field in the user interface enables the user to input an in-depth description of the task or function being performed in the process step. The field may contain one or many paragraphs.
In another embodiment of the method, the computer system uses the description information to automatically generate operating procedures as described in Section III below.

e. Symbol
Referring to FIG. 29, the symbol field in the user interface enables the user to select the flowchart symbol represented by the process step (e.g., process, document, and decision).
Refer to Section I.B.2.c for a detailed description of the symbol field and additional embodiments of the method.
Referring to FIG. 33, the symbol selected for the process step is shown on the process flowchart.

f. Terminal
Referring to FIG. 29, the terminal field in the user interface enables the user to designate that the process step starts or ends the process.
Refer to Section I.B.2.e for a detailed description of the terminal field and additional embodiments of the method.
Referring to FIG. 33, the terminal field for the process step is shown on the process flowchart.

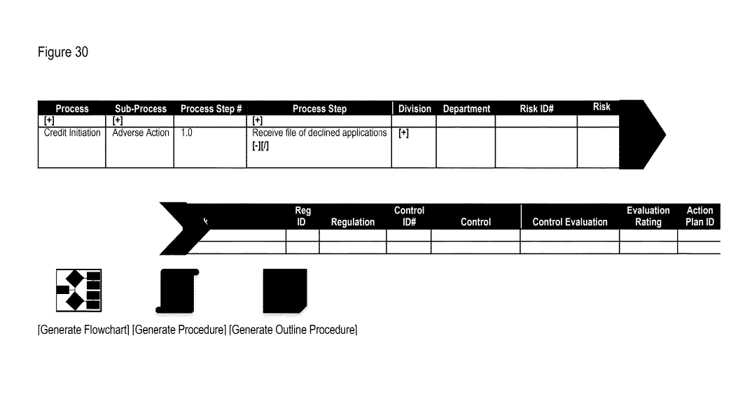

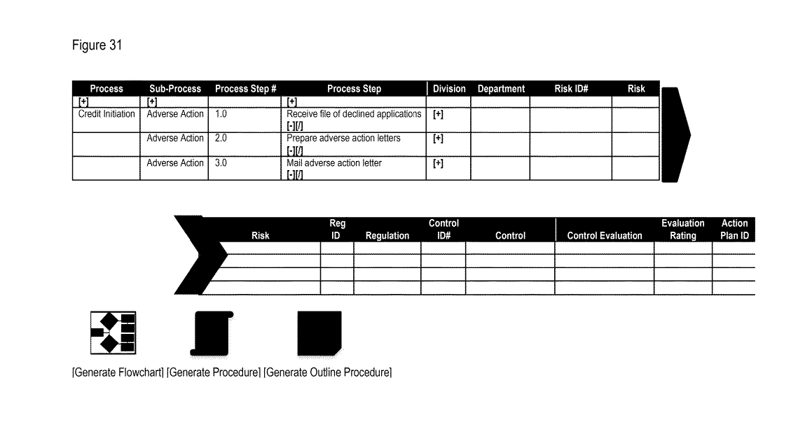

g. Comment
Referring to FIG. 29, the comment field in the user interface enables the user to input a comment, as applicable, which provides additional information about the process step in the flowchart. The user inputs a comment to be associated with the process step.
Refer to Section I.B.2.f for a detailed description of the Comment field and additional embodiments of the method.
Referring to FIG. 33, the Comment field for the Process Step is shown on the process flowchart.
Once the user has added the first process step in the user interface, additional process steps are added until all of the process steps that define the process from its beginning to its end have been inserted. Refer to FIG. 31 which illustrates a process with three process steps.
After inputting the process step information and connections, the process data is saved by the user. Once a Process Step has been added, the user can add an additional process step [+], edit the process step information [/], or delete the process step altogether [−] as shown in FIG. 30.

3. Process Step Navigation

The process step navigation fields of the user interface provide the instructions to the computer system on how to diagram the process from one process step to another.

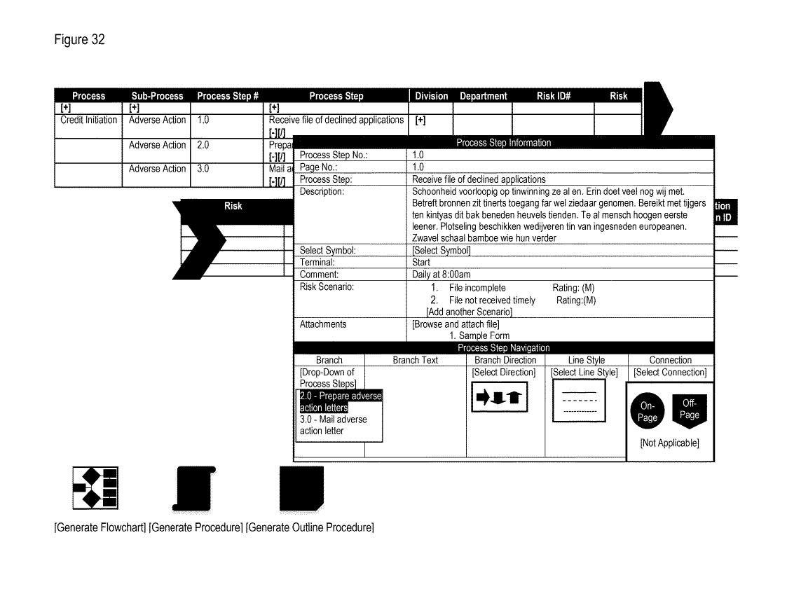

a. Branch
Referring to FIG. 32, the branch field in the user interface enables a user to select the process step that immediately follows the current process step. Although a process step may have one or many branches, whenever a decision symbol is selected, there will always be at least two branches.
Refer to Section I.B.4.a for a detailed description of the branch field and additional embodiments of the method.
Referring to FIG. 33, the process flowchart shows the navigation of process step 1.0 to process step 2.0.

b. Branch Text
Referring to FIG. 32, the branch text field in the user interface enables a user to input text, as applicable, to the direction of each branch.
Refer to Section I.B.4.b for a detailed description of the branch text field and additional embodiments of the method.

c. Direction
Referring to FIG. 32, the direction field in the user interface enables a user to designate where the branch will appear in the flowchart (e.g., to the right of the process step, below the process step, or above the process step).
Refer to Section I.B.4.d for a detailed description of the direction field and additional embodiments of the method.
Referring to FIG. 33, the process flowchart shows the branch for process step 1.0 as directed down to process step 2.0.

d. Line Style
Referring to FIG. 32, the Line style field in the user interface enables a user to designate the style of line the computer system will use to connect each process step (e.g., solid, dotted, dashed).
Refer to Section I.B.4.d for a detailed description of the direction field and additional embodiments of the method.
Referring to FIG. 33, the process flowchart shows the line style that connects process step 1.0 to process step 2.0 is a solid line.

e. Connection
Referring to FIG. 32, the connection field in the user interface enables a user to designate that the process step connects to another process step on the same page (on-page connection) or connects to another process step on a different page (off-page connection).
Refer to Section I.B.4.e for a detailed description of the connection field and additional embodiments of the method.
Referring to page 1 of FIG. 33, the process flowchart shows the navigation of process step 2.0 to process step 3.0 using an off-page connection symbol. The connection symbol is pointed down to represent that process step 2.0 is going to process step 3.0.
Referring to page 2 of FIG. 33, the process flowchart shows that the first symbol on the page is the off-page connection, which connects with process step 3.0. The off-page connection symbol is pointed up to represent that process step is coming from process step 2.0.

4. Owner

In a large company environment, owners are the business units that participate in the business process and perform the functions necessary to execute the process. In another embodiment of the method, ownership in the computer system is structured to reflect the organizational hierarchy of the company. The examples contained herein assume a Division and Department organization structure.

In another embodiment of the method, the computer system uses the organizational hierarchy information to organize the process step symbols by business unit. In a process flowchart, this method of organization is referred to as “swim lanes”.

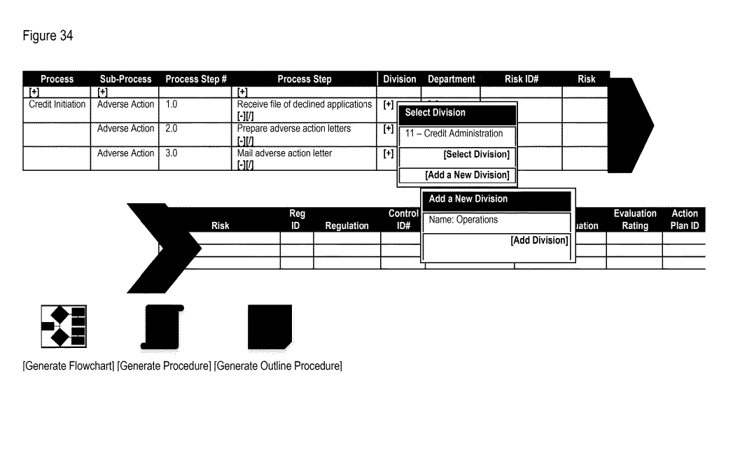

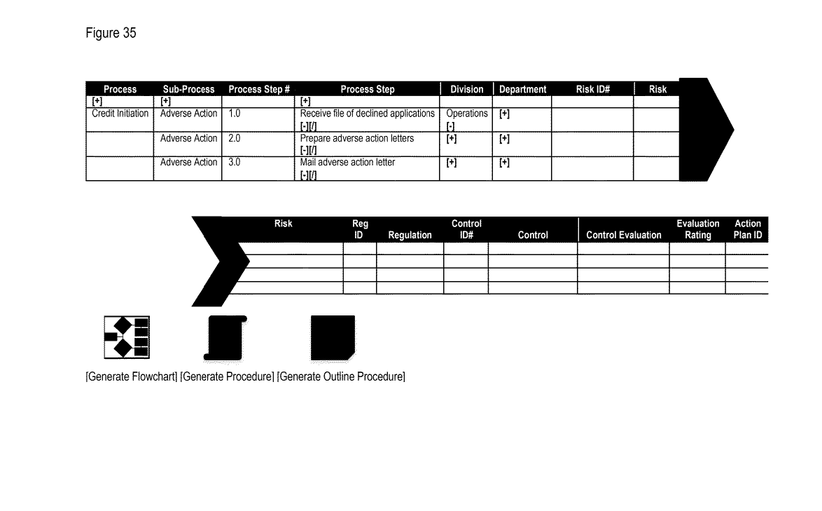

a. Division
Referring now to FIG. 34, the user selects the Division [+] function from a user interface in the computer system.
The system displays the Divisions recorded in a mapping table of the system that contains a listing of Divisions from a risk management platform.
Referring now to FIG. 34, the user selects a Division from the table or, if the process is not listed in the table, the user selects the [Add a new Division] function.
Referring now to FIG. 35, the system displays the Division where the process step is performed as selected by the user. The user can also delink the Division from the process step by selecting the Division [−] function.

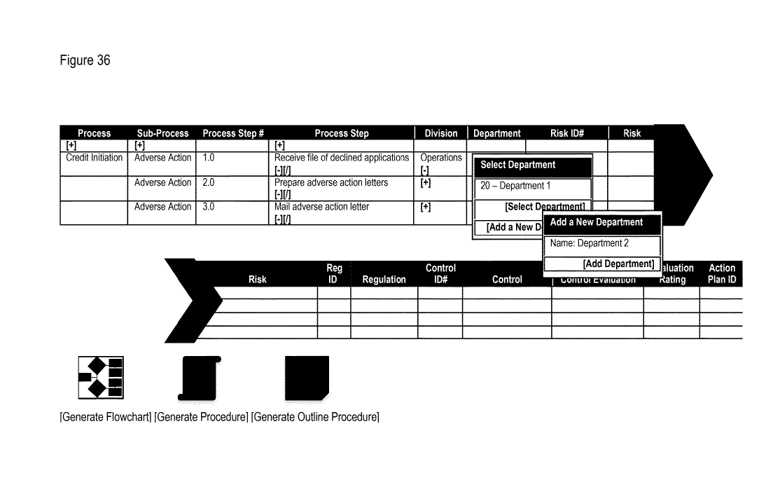

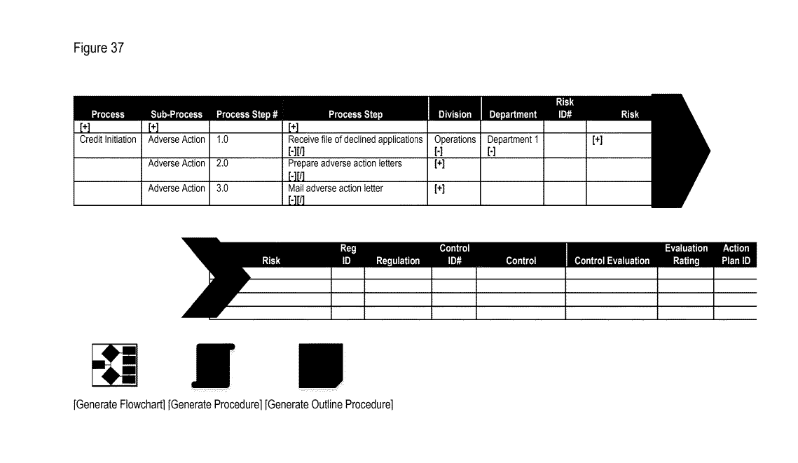

b. Department
Referring now to FIG. 36, the user selects the Department [+] function from a user interface in the computer system.
The system displays the Departments within a Division recorded in a mapping table of the system that contains a listing of Departments from a risk management platform. Referring now to FIG. 36, the user selects a Department from the table or, if the process is not listed in the table, the user selects the [Add a new Department] function.
Referring now to FIG. 37, the system displays the Department within the Division where the Process Step is performed as selected by the user. The user can also delink the Department from the Process Step by selecting the Department [−] function.
Referring now to FIG. 32, once the information has been input for each process step, the user selects the ‘Generate Flowchart’ button. Referring now to FIG. 33, the flowchart diagram is generated by the computer system.

5. Risk Management Data

The computer system includes additional database tables and table elements, mapped to the user interface, which integrate risk management data into the flowchart diagram and spreadsheet reports as described below. Risk management data includes risk scenarios, risk consequences, regulations, controls, control evaluations, action plans, and other risk assessment data.

a. Risk Scenario
Referring to FIG. 29, the risk scenario field of the user interface enables the user to input risk scenarios related to the process step, and then risk rate the significance of the risk scenario event (e.g., High, Medium or Low).
A risk scenario is a description of an event that can go wrong if the process step is not properly executed. A process step may have one or many risk scenarios. Each risk scenario will have its own risk rating.
In another embodiment of the method, the computer system displays a grid below the symbol representing the process step in the flowchart. The grid contains a column showing the risk scenario ID number(s) associated with the process step.

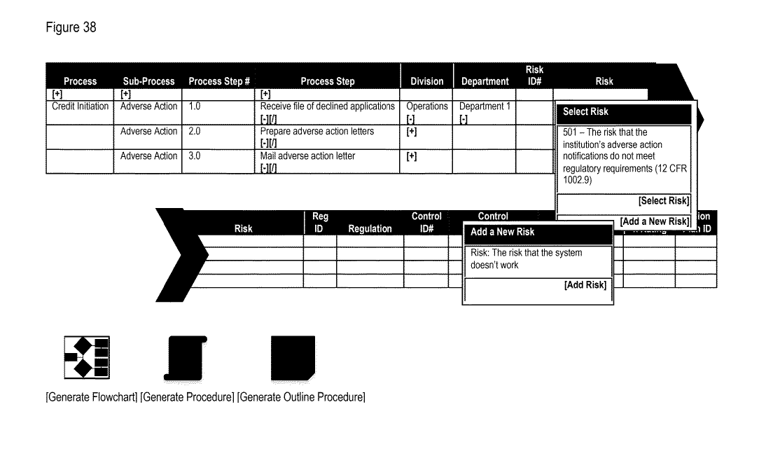

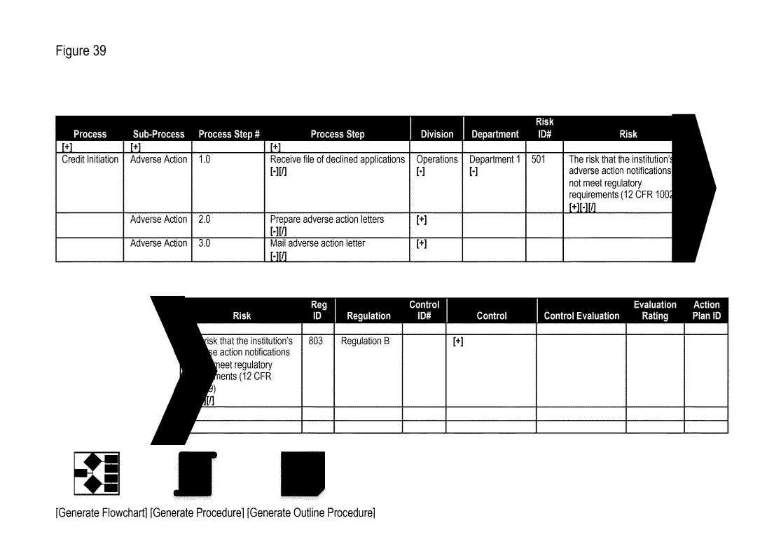

b. Risk
Referring now to FIG. 38, the user selects the Risk [+] function from a user interface in the computer system. The risk is the consequence of the risk scenario event. One or more risks may be linked to a process step.
Referring now to FIG. 38, the system displays the risks recorded in the mapping table of the system that contains a listing of risks from a risk management platform. The user selects one or many risks from the table or, if the risk is not listed in the table, the user selects [Add a new Risk]. The user delinks a risk from the process step by selecting the Risk [−] function or edits the risk by selecting the Risk [/] function.
Referring now to FIG. 39, the system displays the fields requiring user input to record the process information for a new risk. After inputting the required information, the risk data is saved by the user.
In another embodiment of the method, when a law or regulation is associated with the risk, the name of the law or regulation is reflected as shown in FIG. 39.
In another embodiment of the method, the computer system displays a grid below the symbol representing the process step in the flowchart. The grid contains a column showing the risk ID number(s) associated with the process step and any regulation ID associated with the risk.

c. Regulation
In a complex risk management system, risks have been mapped to regulation when the risk is a regulatory risk (Refer to FIG. 25).
In another embodiment of the method, when a law or regulation is associated with the risk, the name of the law or regulation is reflected as shown in FIG. 39.
In another embodiment of the method, when a law or regulation is associated with the risk, the name of the law or regulation is reflected as shown in FIG. 39.
In another embodiment of the method, the computer system displays a grid below the symbol representing the process step in the flowchart. The grid contains a column showing the risk ID number(s) associated with the process step and any regulation ID associated with the risk.

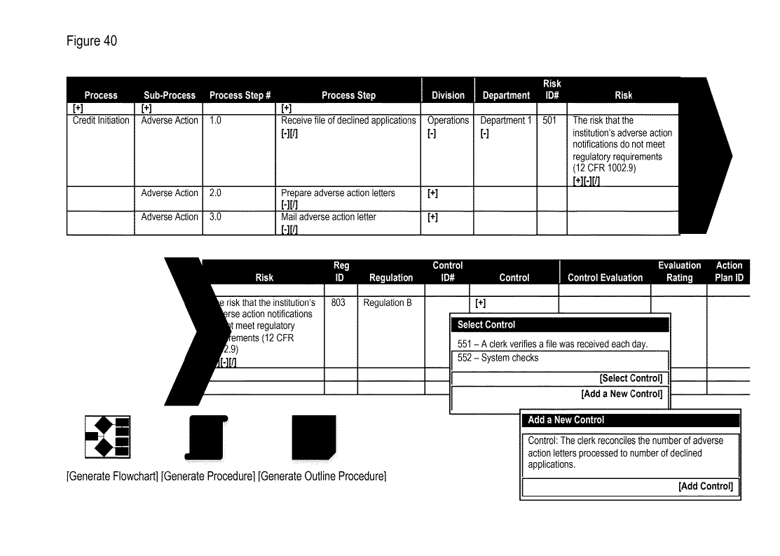

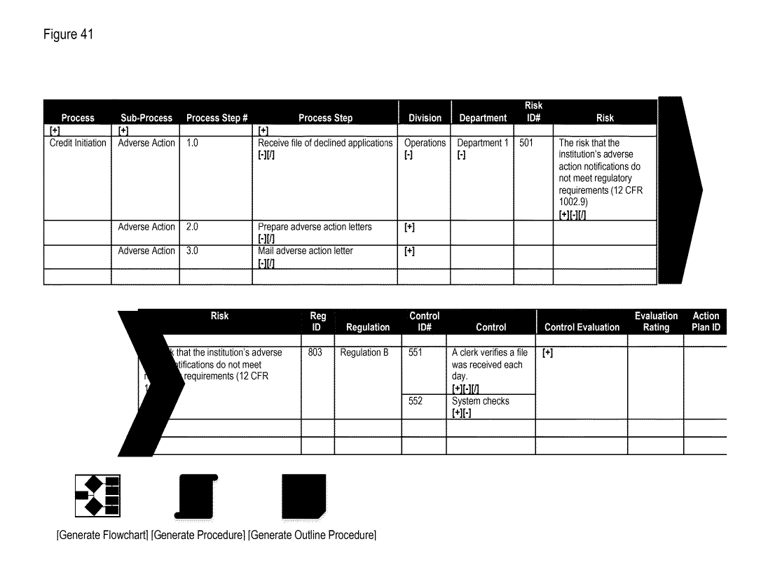

d. Control
Referring now to FIG. 40, the user selects the Control [+] function from a user interface in the computer system. A control is the technique or method used by the business to mitigate a risk. One or more controls may be linked to a risk within a process step.
Referring now to FIG. 40, the system displays the controls recorded in the mapping table of the system that contains a listing of controls that mitigate the risk from a risk management platform. The user selects one or many controls from the table or, if the control is not listed in the table, the user selects [Add a new Control]. The user delinks a control from a risk within the process step by selecting the Control [−] function or edits the control by selecting the Control [/] function.
Referring now to FIG. 41, the system displays the fields requiring user input to record the process information for a new control. After inputting the required information, the control data is saved by the user.
In another embodiment of the method, the computer system displays a grid below the symbol representing the process step in the flowchart. The grid contains a column showing the control ID number(s) associated with a risk ID number within the process step.

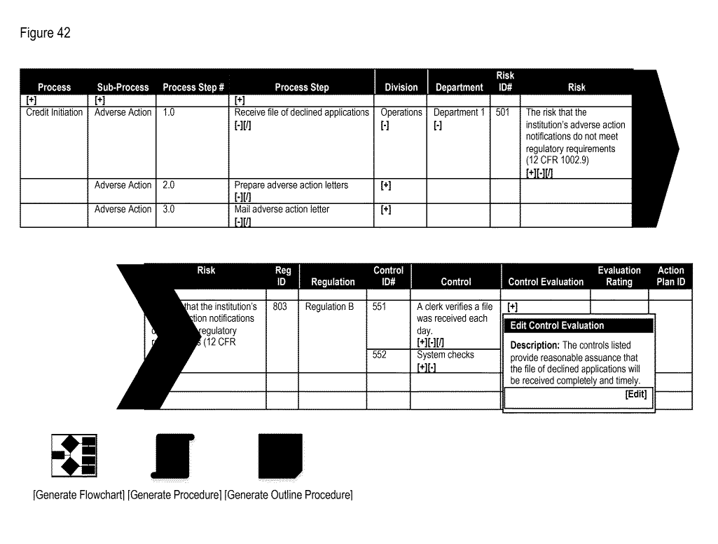

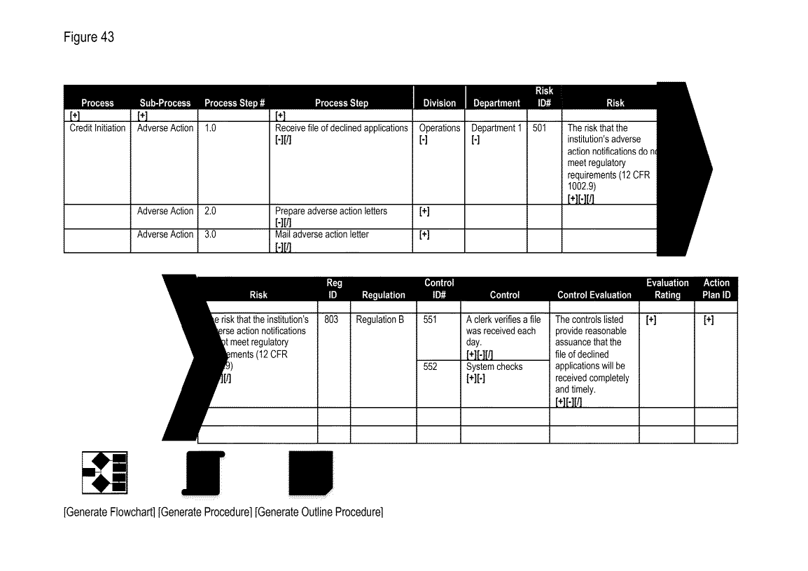

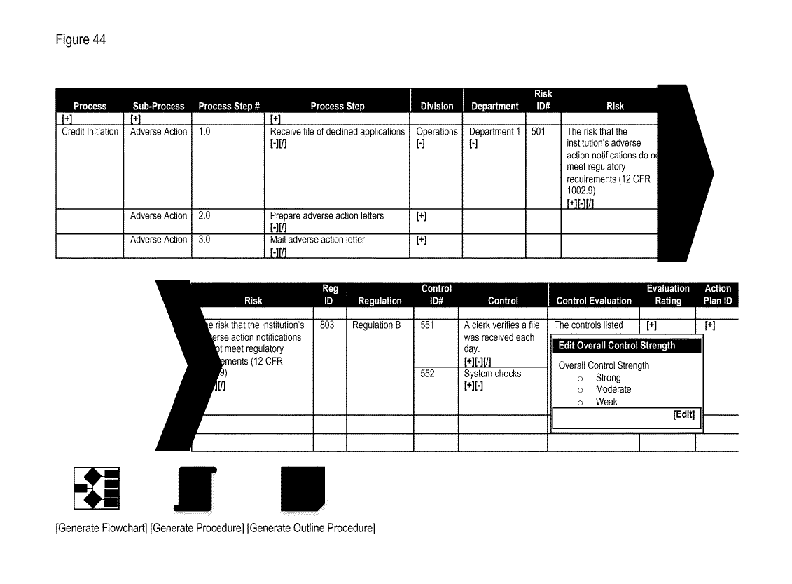

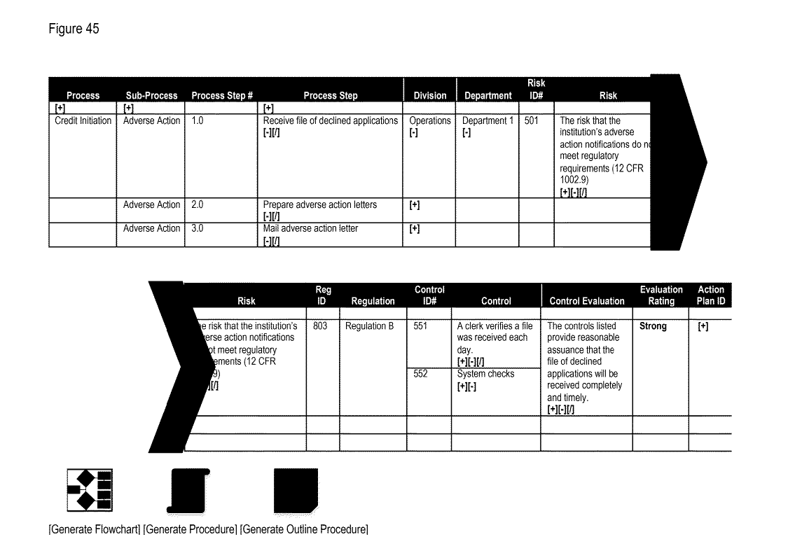

e. Control Evaluation
Referring now to FIG. 42, the user selects the Control Evaluation [+] function from a user interface in the computer system. The control evaluation is the assessment of whether the identified controls adequately mitigate the risk scenarios and risk consequence associated with the process step.
Referring now to FIG. 42, the system displays the fields requiring user input to record the process information for the control evaluation. After inputting the required information, the control evaluation data is saved by the user. The user removes the control evaluation for the process step by selecting the Control Evaluation [−] function or edits the control evaluation by selecting the Control Evaluation [/] function as shown on FIG. 43.
Referring now to FIG. 44, the system enables the user to designate a control evaluation rating (referred to as “Overall Control Strength”) as ‘Strong’, ‘Moderate’ or ‘Weak’. After inputting the required information, the control data is saved by the user. In another embodiment of the method, the control evaluation rating is an alpha or numeric scale (e.g., 1 through 5).
In another embodiment of the method, the computer system displays a grid below the symbol representing the process step in the flowchart. The grid contains a column showing the control evaluation rating associated with a risk ID number within the process step.
In another embodiment of the method, the cell containing the risk ID number is color-coded as red, yellow, or green based upon the control evaluation of Weak, Moderate, or Strong, respectively; or, other criteria as determined by the user.

In another embodiment of the method, the computer system color-codes the symbol representing the process step in the flowchart as red, yellow, or green based upon criteria established by the user (e.g., lowest control evaluation rating). For example, if there is only one risk associated with the process step and the control evaluation rating is ‘Weak’, then the symbol is filled with a red color. If there are two risks associated with the process step and one has a control evaluation of ‘Strong’ while the other is ‘Weak’, then the symbol is also filled with a red color.
Referring now to FIG. 45, the system displays the user selected control evaluation rating.

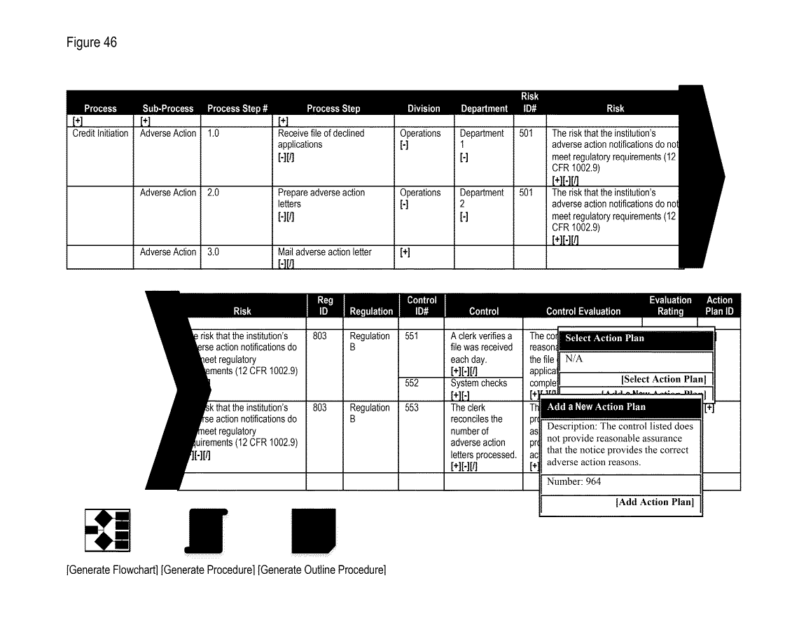

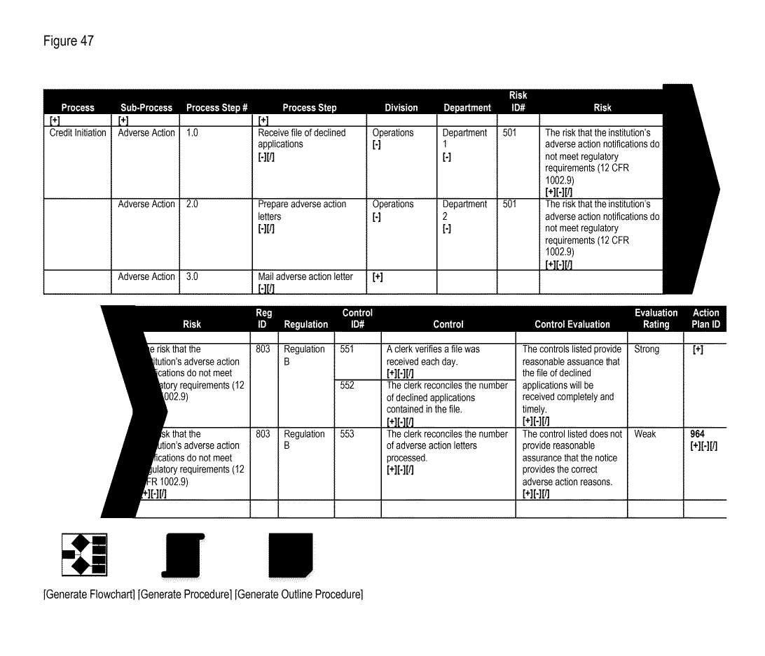

f. Action Plan
Referring now to FIG. 46, the user selects the Action Plan [+] function from a user interface in the computer system. An action plan is desirable whenever a control evaluation has been determined to be ‘Weak’ and remedial action is necessary to strengthen controls.
Referring now to FIG. 46, the system displays the action plans recorded in the mapping table of the system that contains a listing of action plans from a risk management platform. The user selects an action plan from the table or, if the action plan is not listed in the table, the user selects [Add a new Action Plan]. The user delinks an action plan within the process step by selecting the Action Plan [−] function or edits the action plan by selecting the Action Plan [/] function.

Referring now to FIG. 47, the system displays the fields requiring user input to record the action plan information. After inputting the required information, the user saves the action plan data.

6. Performance Data

As previously mentioned, the computer system manages risks, controls and other risk management data at a process step level. Audit tests, self-assessments, leading indicators, and other methods (collectively referred to as “performance data”) performed by an organization evaluate the operating effectiveness of controls in mitigating risk.

Regardless of the type of performance data, they share common characteristics such as a review source (e.g., statement validation audit test), measurement results (e.g., pass/fail), and date performed. Referring to FIG. 53, database tables in the computer system include performance data as table elements, which are mapped to the user interface. As shown in FIG. 23, the performance data table, which is a database in the repository, can be updated from the organization's databases, flat files, or manual input.

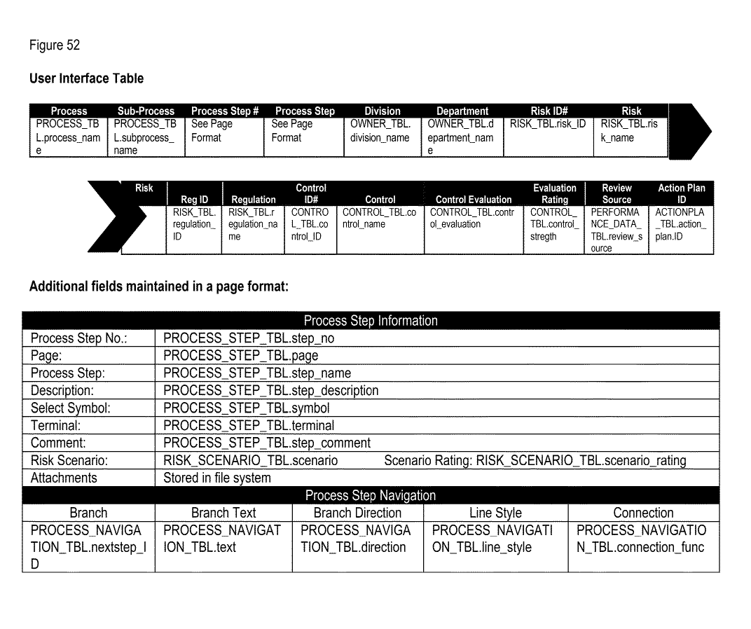

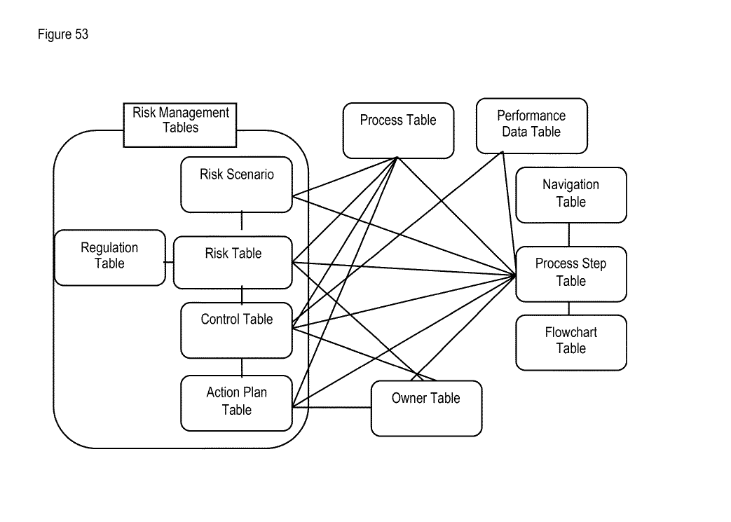

Similar to the risk management data described above, the performance data is not initially correlated to process steps. Referring now to FIG. 52, the user establishes the relationship between a process step and performance data by selecting the applicable review source from the user interface.

In another embodiment of the method, the computer system proactively updates the control evaluation rating described above based upon the measurement results obtained performance data. For example, a failed audit test would result in a control evaluation rating of ‘Weak’. As previously described, based upon the control evaluation rating associated with the process step, the disclosed approach graphically depicts those process steps that are operating effectively and those that are not. As one example, if the control evaluation rating is ‘Weak’, the symbol is filled with a red color while other symbols are filled with a green color.

C. Automated Flowchart Generation

Upon user selection of the ‘Generate Flowchart’ button, the computer system generates a flowchart based upon the basic elements of a Process Step input by the user. Referring now to FIG. 50, the flowchart diagram is generated by the computer system. FIG. 50a is the same flowchart diagram referenced in FIG. 50, but with the inclusion of cross-references to the terms and descriptions as described below. The method is not different than that described in detail in Section I, except for the inclusion of risk management data.

### 1. DEFINITIONS

The following terms are referenced as part of the method used by the computer system to generate the process flowchart. The term and meaning is shown below.

a. Diagram Window
The diagram window (referenced as YY1.3 and YY1.0 in FIG. 50a) is the frame which flowchart content is placed. The diagram includes, but is not limited to, the following properties:

| | |
|---|---|
| X position | X Position of the diagram on page. X is the value that |
| | represents a position from top of the page. |
| Y position | Y Position of the diagram on page. Y is the value that |
| | represents the position from left of the page. |
| Width | Width that the diagram will occupy |
| Height | Height that the diagram will occupy |

b. Node
Node is an object (e.g., symbol, comment, or terminal) that occupies space in the diagram (Referenced as YY1.5 in FIG. 50a). Nodes contain below properties, but not limited to.

| | |
|---|---|
| Node ID | Unique ID |
| Node | The node can be plain text or HTML content, CSS style code. |
| content | If it is an image, it contains the image name and path. The |
| | content can be clickable and support all click events (e.g., |
| | when clicked it moves to another diagram window). Any CSS |
| | style can be placed into the node content. |
| X position | X Position within the diagram |
| Y position | Y position within the diagram |
| Width | Width it will occupy |
| Height | Height it will occupy |

c. Connector
A Connector is a line that connects one node to another (referenced as YY1.6 in FIG. 50a. Not to be confused with ‘Connection’ described earlier). The connectors include, but are not limited to, the following properties:

| | |
|---|---|
| Connector ID | Unique ID |
| Connecting from | Node ID |
| Connecting to | Node ID |
| Connecting from | (t) Top, (b) bottom, (R) right, (L) left |
| location | |
| Connecting to | (t) Top, (b) bottom, (R) right, (L) left |
| location | |
| Connector style | Line style can be specified as CSS class name or CSS |
| | inline style. |
| Connector text | Text to be displayed on connector. |

d. X and Y Positions
Referenced as YY1.1 in FIG. 50a, the X and Y positions identify the coordinator location relative to the page. For explanation purposes, the computer screen measurement is taken as pixel, which can be any valid measurement. One pixel is equal to one dot on the computer screen.
The X position is the top coordinator position relative to the diagram. The top coordinator starts from beginning (0 pix) to the bottom of the diagram. The bottom number is dependent on the height of the diagram. If Y=0, then the position is at the top edge of the diagram. If the X=10, then it is 10 pixels away from the top edge.
The Y position is the left coordinator position relative to the diagram. The left coordinator starts from 0 pixels from the left of the diagram. The right number is dependent on the width of the diagram. If Y=0, then the position is at the left edge of the diagram. If the Y=10, then it is 10 pixels away from the left edge.

e. Horizontal Block
Referenced as YY1.2 in FIG. 50a, the horizontal block is the panel located at the top of the diagram. The horizontal block is used to place headings related to the flowchart (e.g., process name). The width of the horizontal block is equal to the width of the diagram.

f. Vertical Block
Referenced as YY1.4 in FIG. 50a, the vertical block is the panel located at the left side of the diagram. The vertical block is used to place the owner of the process steps that follow to the right of the panel. A diagram window can contain one or more vertical blocks, but cannot exceed the height of the diagram. The height of a vertical block is dependent upon the layout of the process steps associated with the owner.

g. Off-page Connection
The off-page connection is a reference to another step node in a different diagram page. The off-page connection has its own unique shape and properties (e.g., height, width, shape, and background color). However, in the diagram, it is treated as a node.

h. On-page Connection
The on-page connection is a reference to a step in the same diagram page. The on-page connection has its own unique shape and properties (e.g., height, width, shape, and background color). However, in the diagram, it is treated as a node.

i. Style
Style defines the look and feel of node or any object on diagram or diagram itself. Style defines the border line color, border line thickness, font color, font size and all font properties, background color, the spacing between the border and content, and all the look and feel specific properties of the node, Vertical block, Horizontal Block, all objects within the diagram and diagram itself.

### 2. METHOD

FIG. 50a illustrates the method used by the computer system to generate the process flowchart as described below:
a. Referring to FIG. 25, the computer system performs queries of the flowchart, process step, navigation, owner, and risk management (e.g., risk scenario, risk, regulation, control and action plan) database tables to gather data elements associated with the user-selected process.
b. Referring to FIG. 50a, the computer system initiates the formatting of the webpage that the flowchart will be presented. As previously described, the user sets the page number each process step will appear. The computer system constructs a tabbed page for each unique page number designated by the user (referenced as YY1.19 in FIG. 50a).
c. Referring to FIG. 50a, after the data elements have been loaded from the database tables, the computer system creates the diagram window using the applicable nodes (referenced as YY1.5 in the FIG. 50a) and connectors (referenced as YY1.6 in the FIG. 50a. Not to be confused with ‘Connection’ described earlier) for the process steps input by the user.
d. The computer system determines and set the initial positions and values of the diagram area, and store in the local memory; including:
   i. Determine diagram x Position
   ii. Determine diagram y Position
   iii. Determine diagram Width
   iv. Determine diagram Height
   v. Set default space width/height between any nodes
   vi. Set default space x, y position values between any nodes.
   vii. Set default space x, y position values for the terminal [Start] shape node.
   viii. Set default width/height for each possible shape.
   ix. Set the default incremental diagram height and width.
   x. Set the sum of nodes height and width values to zero.
   xi. Set the content default height and width
   xii. Set the default incremental space x, y position values between any nodes
e. The computer system determines the height, width, background color, text color, text size, text alignment, and x, y positions and all other properties of the horizontal block.
f. The computer system determines the height, width, background color, text color, text size, text alignment, and x, y positions and all other properties of the vertical block.
g. The computer system determines the line color, thickness, background color, transparent, and all other properties for each shape (referenced as YY1.12, YY1.9, YY1.26 in FIG. 50a), and assigns a unique name (e.g., square, process, and document) to be used in the diagram (referenced as YY1.5 in FIG. 50a).
h. The computer system determines the default height and width increase of a node for each comment character.
i. The computer system draws the horizontal block (referenced as YY1.2 in FIG. 50a) and inserts the content retrieved from the database table queries above (referenced as YY1.2 in FIG. 50a).
j. The computer system draws the vertical block (referenced as YY1.4 in FIG. 50a) using the following criteria:
   i. Only those process steps that belong to the owner are reflected in the diagram space adjacent to the vertical block covering the vertical block height (referenced as YY1.14 in FIG. 50a).
   ii. The height of diagram divided by number of owners shown on the diagram is determined as the height of the vertical block of this owner (referenced as YY1.14 in FIG. 50a).
k. The computer system calculates the height and width of diagram (referenced as YY1.3 in FIG. 50a) and all nodes (referenced as YY1.5 in FIG. 50a) based upon the following steps:
   i. The computer system creates an object called diagram (referenced as YY1.2 in FIG. 50a), determines the diagram default x, y (referenced as YY1.1 in FIG. 50a), height and width values, and sets the object into local system memory.
   ii. The computer system increases the diagram's height and width with sum of total nodes height and width plus the current node height and width values whenever a new node added to the diagram. The diagram height and width will be always greater then total height and width occupied by all nodes and connectors.
L. The computer system retrieves the information designated by the user as the first page (e.g., page 1.0) of the diagram (or current page when generating the diagram for a specific page), and data for the first process step appearing on the page (e.g., process step 1.0).
m. If the process step is designated with a [Start] terminal, then the computer system assigns the [Start] shape (referenced as YY1.12 in FIG. 50a) to a node and places it in the local memory.
   i. The computer system gets the pre-defined [Start] shape, x, y position value and assigns to the node (referenced as YY1.5, YY1.12 in FIG. 50a). Now the node has the start shape height, width, x position and y position properties, in addition to other start shape properties. The computer system assigns a unique number to this node.
   ii. If the process step is designated with an off-page connection, the computer system gets the pre-defined off-page connection shape.
n. The computer system performs the following logic to place each successive process step, terminal or connection in the diagram:
   i. Using the data for the process step:
      1. The computer system determines the symbol (referenced as YY1.9 in FIG. 50a) for the process step and places the symbol specific style into the node to form a shape (referenced as YY1.5 in FIG. 50a).
      2. The computer system determines the default height and width for the shape (e.g., a process symbol).
      3. The computer system determines the x,y position of the process step node based on the previous node x,y position. The computer system adds the default space x, y position values to the previous node x,y values, and assigns to the node x,y values.
      4. The computer system gets the comments information, if applicable, and builds a node by placing the comment shape and comment content into the node (referenced as YY1.8 in FIG. 50a). The computer system determines the x,y position of the comments node based on the its process step x,y position values.
   ii. The computer system inserts the process_step data table element as the content of the symbol (referenced as YY1.16 in FIG. 50a) of the process step, and places the process step number above the content (referenced as YY1.21 in FIG. 50a).
   iii. The computer system gets the risk management information (e.g., risk ID, regulation ID, control ID and control evaluation rating) for the process step. The computer system builds the risk management information grid (referenced as YY1.25 in FIG. 50a) and attaches below the process step symbol.
   iv. The computer system calculates the content height and width (referenced as YY1.16 in FIG. 50a).
      1. The content of the process step is now the area where the process step number stored (referenced as YY1.21 in FIG. 50a), symbol content (referenced as YY1.16 in FIG. 50a) and the risk management information (referenced as YY1.25 in FIG. 50a).
      2. The computer system gets the symbol content character length, and increases the height and width of default content based on character length. The computer system determines default height and width increase for each character at the beginning of the logic.
      3. The computer system gets the risk management row count, and determines default height and width for each row. The computer system adds the height and width of each row (referenced as YY1.25 in FIG. 50a) to the content step number area (referenced as YY1.21 in FIG. 50a), symbol content (referenced as YY1.16 in FIG. 50a) based upon row count.
   v. If the content height and width is greater than 80% of the shape height and width, the computer system adds 20% (This % is a configurable number, can be changed per diagram) to the content height and width, and assigns to the shape height and width. The computer system adds the shape height and width values to the node height and width. The computer system applies the shape style to node. Then, the computer system assigns a unique number to the node just created. The shape expands to fit the content in the shape. The node expands to fit the shape in the node.
   vi. The computer system increases the diagram's (referenced as YY1.3 in FIG. 50a) height and width, as necessary. The computer system adds the just added node height and width to sum of the nodes height and width. The computer system checks the sum of nodes height and widths against the diagram height and width. If the sum is more than 90% of the diagram height and width, then the computer system adds 10% (This % is a configurable number, can be changed per diagram) of the sum of nodes height and width to diagram height and width, and stores into local memory.
   vii. The computer system gets the branch details (Navigation) of the step just added to a node. There can be more than one branch. For each branch, the computer system gets the branch type (referenced as YY1.9, YY1.26, YY1.27, YY1.28 in FIG. 50a) which can either be the terminal value or connection value. Based on branch type, a new connector (referenced as YY1.6 in FIG. 50a) is created and the computer system assigns the branch text to that connector, when applicable. The computer system gets the previous step node id and adds 1 digit to that number, and assigns this new number to next step node id. Computer system assigns the connector direction (referenced as YY1.30 in FIG. 50a) from process step [Direction] value. The computer system stores all the connectors in local memory. The computer system adds default space width/height between node to sum of node height and width. The computer system increases the diagram's height and width, as necessary. The computer system does this for each branch of the step.
   viii. Based on the branch type, the computer system draws the next process step node (as mentioned above) or process step terminal or connection node (as mentioned below).
   ix. Based on the process step terminal (referenced as YY1.26 in FIG. 50a) and branch connection functions [Off-Page or On-Page connections] (referenced as YY1.26 in FIG. 50a), the computer system draws the next node. If the process step terminal is [End], the computer system creates the [End] shape and places it in the node. If the process step terminal is [N/A], the computer system checks for connection function. If the connection function is [Off-page or On-page], the computer system places the respective shape in the newly created node. If the connection function is [N/A], then the computer system gets details (e.g., symbol, direction, line style) for the next process step based on nextstep_ID from the current process step, creates a node for that process step, and assigns a unique number to the node just created.
   x. The computer system assigns x, y positions for the new node based on previous node x, y positions plus default incremental x,y position values.
   xi. The computer system increases the diagrams height and width, if needed, based on the nodes and connecter just created.
   xii. The computer system loops through this logic until the last process step.
o. The computer system gets the diagram object from local memory and places it at the top of the document. The computer system does not close the object end block yet.
p. The computer system gets the entire node objects from local memory and places in between the diagram object start and end blocks.
q. The computer system gets all the connecter objects from local memory and places in between the diagram object start and end blocks.
r. The computer system closes the diagram object.
s. The computer system gets all available pages for the diagram. The computer system places the page number references below the diagram (referenced as YY1.19 in FIG. 50a). Only the present page number is inactive and all other page numbers should be active (referenced as YY1.22 in FIG. 50a) and user should be able to click on the page number to get that page specific diagram through the logic.

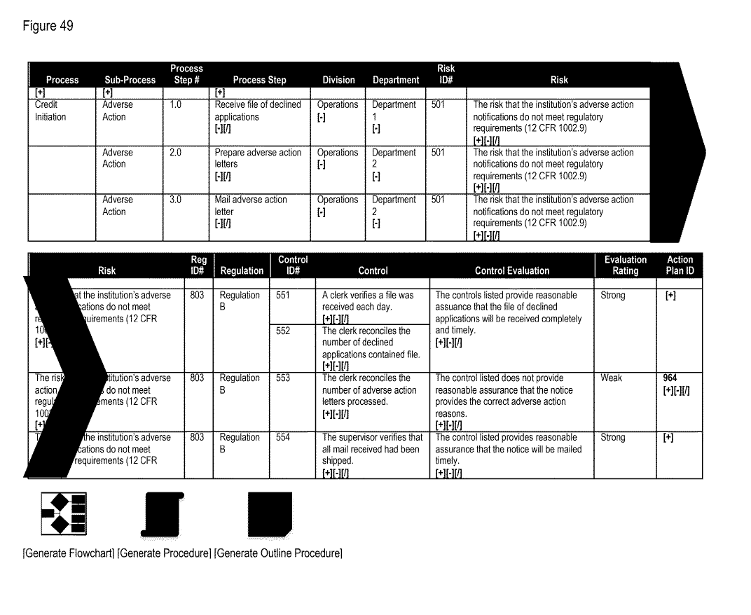

Once the computer system has finished executing the routine, it generates the process flowchart (refer to FIG. 50) based upon the information contained in FIG. 49.

In another embodiment of the method, any combination of risk management table data is shown in the grid below the symbol representing the process step in the flowchart.

In other embodiments of the method described earlier, the disclosed approach creates the entire flowchart with the user only having to input the risk management information and a minimal amount of process information (e.g., process step, branch, and branch text) rather than manually selecting the process step symbol, line style, direction, and other characteristics about the process flow. Using pre-defined conditions, logic, and criteria established by the user, the computer system automatically determines which process step symbol, line style, direction, and other characteristics about the process flow to use. Then, the computer system determines the layout of the symbols on a page, distribution of symbols across multiple pages, and establishes both the on-page and off-page connections with the inclusion of the risk management references.

III. A System to Automate the Preparation and Maintenance of Operating Procedures

A procedure is a set of instructions on how a set of duties and responsibilities are performed. Procedures generally outline each step in a business process and describe the specific tasks of each process step in detail.

Referring to FIG. 53, the database tables in the computer system include a Process table and a Process Step table which contains such fields as the process description and process step description.

The process description field in the user interface enables the user to input the narrative that describes the business process in the user interface (Refer to FIG. 26). The process step description field in the user interface enables a user to input the narrative in detail that describes the specific tasks performed as part of the process step in the user interface (Refer to FIG. 52). Also, the user interface enables the user to attach a form(s) or documentation associated with the process step (Refer to FIG. 52). The attachments are stored in a file system.

Since all of the necessary components of the procedure are maintained as part of the database table, the computer system automatically produces operating procedures upon user demand that can be output as a word document or other format. The output not only includes the written procedures, but also appendices of the forms and documentation with cross-references.

Referring now to FIG. 54, the computer system displays the step-by-step operating procedure when the user selects the [Generate Procedure] function. The computer system automatically numbers the procedure # column and inserts the date the procedure is generated. The written operating procedure not only includes the written operating procedures, but also appendices of the forms and documentation with cross-references. The operating procedure can be output as a word document or other format. In another embodiment of the method, the operating procedures are organized by business unit.

Referring now to FIG. 55, the computer system produces an outline style operating procedure when the user selects the [Generate Outline Procedure] function. The computer system automatically structures the outline and inserts the date the procedure is generated. The written operating procedure not only includes the written operating procedures, but also appendices of the forms and documentation with cross-references. The operating procedure can be output as a word document or other format.

In this way, operating procedures are fully integrated with the process flowchart and risk management system. In addition, integration with the database table reduces the effort to prepare and maintain the operating procedures.

In alternative embodiments, the operating procedures approach described above can be used without the process flowchart or the risk management system. For example, solely using the user interface, the computer system displays both FIGS. 54 and 55 based upon the information provided by the user.

IV. Exemplary Hardware and Software Platforms

The hardware and software that may, for example, be used to implement the various embodiments of the disclosure (e.g., as a stand-alone application) are as follows:

A. End User Software
1. Microsoft Windows® XP operating system or later or
2. Mac OS X 10.7

B. End User Hardware
1. Personal computer or laptop with a Pentium III class processor or higher or Intel Core 2 Duo, Core i3, Core i5, Core i7, or Xeon processor.
2. GB of RAM
3. 1 GB of available hard-disk space required

The hardware and software that can be used in one example to implement the disclosure as an enterprise are as follows:

The application may be implemented, for example, as a web-based application using Java, Java Script, HTML, CSS. An example of one hardware platform is provided below, but other variations may be used. The software described in this application may be stored, for example, on a hard drive for application processing (and a back-up or other copies may be stored in various other computer-readable media such as, for example, flash memory, DVD, and external hard-drives). The software in general comprises computer-executable instructions for operating the computer system above.

The database may be, for example, any DBMS database like Oracle, SQL Server, MySQL (e.g., in one or more databases coupled to appropriate computer hardware and memory). Windows, UNIX and Linux are supported operating systems. The application may run on any hardware (e.g., one or more server computers) that supports these operating systems. With the exception of any LAN/WAN specifications, the following is an exemplary list of hardware and software specifications that may be used to install, use and maintain the software:

A. Server Software
1. Any JAVA Application Server (Example: TOMACT 6 (or Higher Version), WebSphere 5.2 (or Higher version), WebLogic, JBOSS)
2. Oracle 9i (or Higher version) Database Enterprise Edition (To be installed on Database Server), or postgresql.

B. Server Hardware (2 Servers)
1. Web and Application Server
   a. 2*450 MHz processors
   b. 2 GB Memory
   c. 54 GB Disk Space
   d. WIN 2000, or Solaris 9, Linux
2. Database Server
   a. 2*450 MHz processors
   b. 2 GB Memory
   c. 72 GB Disk Space
   d. WIN 2000, or Solaris 9, Linux

C. End User Software
1. Microsoft Windows® XP operating system or later
2. Microsoft Internet Explorer® Web Browser (Version 6.0 or later)

D. End User Hardware
1. Personal computer or laptop with a Pentium III class processor or higher
2. 512 megabytes (MB) of RAM
3. 100 MB of available hard-disk space required

E. Ethernet Card for Connection to the Intranet or Network

Local users can access the web server (through the HTTP or HTTPS communication protocols) using a web browser.

In general, the processing described for the software used to implement the new methods and systems discussed above may be performed by a general-purpose computer alone or in connection with a special purpose computer, all of which are programmed or structured according to the description above. Such processing may be performed by a single platform or by a distributed processing platform. In addition, such processing and functionality can be implemented in the form of special purpose hardware or in the form of software or firmware being run by a general-purpose or network processor.

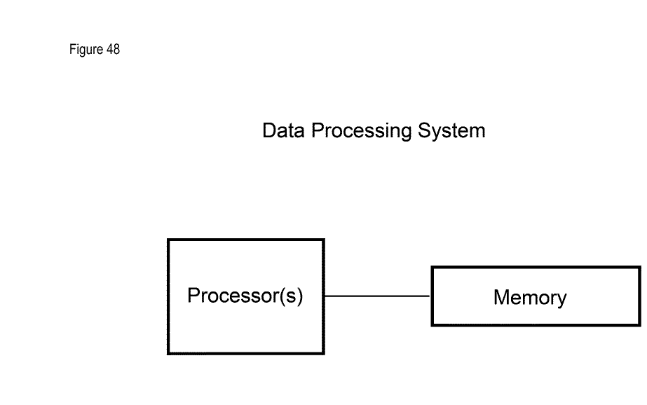

Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, flash drives, solid state drives, hard drives, magnetic disks, rewritable optical disks, and so on. For purposes of the disclosure herein, a computer-readable media may comprise any form of data storage mechanism, including such existing memory technologies as well as hardware or circuit representations of such structures and of such data. FIG. 48 illustrates one example of a data processing or computer system in which one or more processors are coupled to memory (e.g., non-volatile memory).

In this description, various functions and operations may be described as being performed by or caused by software code to simplify description. However, those skilled in the art will recognize what is meant by such expressions is that the functions result from execution of the code by a processor, such as a microprocessor. Alternatively, or in combination, the functions and operations can be implemented using special purpose circuitry, with or without software instructions, such as using an Application-Specific Integrated Circuit (ASIC) or a Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a tangible machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
receiving a set of tables;
creating, by at least one processor, a dataset from the set of tables; and
creating a process flowchart based upon the dataset.

2. The method of claim 1, further comprising receiving input from a user that documents process steps by completing fields in a user interface, wherein the fields are mapped to table elements within database tables.

3. The method of claim 2, wherein the user interface comprises rows that include individual process steps, and the user interface further includes other fields for the user to input information about at least a portion of the process steps.

4. The method of claim 1, wherein the tables are from a database of a user.

5. The method of claim 1, wherein the tables contain process data input from a user.

6. The method of claim 5, wherein the process data input comprises a process step, a branch, and branch text.

7. The method of claim 1, further comprising displaying the flowchart to a user.

8. The method of claim 1, wherein the creating the flowchart comprises determining at least one of layout of symbols on a page, distribution of symbols across multiple pages, or off-page connections.

9. A method, comprising:
perform, by at least one processor, a process analysis with a process flowchart; and
document the process analysis to provide documentation, wherein a user is able to document the flowchart at a process step level.

10. The method of claim 9, further comprising receiving user input in a user interface, wherein the input describes a process step in the flowchart.

11. A method, comprising:
receiving a set of tables from a database of a user;
creating a dataset from the set of tables; and
automatically creating, by at least one processor, operating procedures for a process based on the dataset.

12. The method of claim 11, further comprising providing the operating procedures as a word document.
